(19) United States
(12) Patent Application Publication
(10) Pub. No.: US 2019/0171045 A1
(43) Pub. Date: Jun. 6, 2019

(54) DISPLAY DEVICE

(71) Applicant: SHARP KABUSHIKI KAISHA, Sakai City, Osaka (JP)

(72) Inventor: JUNICHI MASUDA, Sakai City (JP)

(73) Assignee: Sharp Kabushiki Kaisha, Sakai City, Osaka (JP)

(21) Appl. No.: 16/305,860

(22) PCT Filed: May 23, 2017
(86) PCT No.: PCT/JP2017/019161

§ 371 Date: Nov. 29, 2018

(30) Foreign Application Priority Data
May 30, 2016 (JP) 2016-107690

(51) Int. Cl. G02F 1/137; G02F 1/1335; F21V 8/00; G02F 1/1334; G02F 1/1339

(52) U.S. Cl. CPC G02F 1/137; G02F 1/13362; G02B 6/0055; G09G 3/342; G02F 1/133514; G02F 1/1334; G02F 1/1339; G02F 1/133528

(57) ABSTRACT

Provided is a display device that can increase the quantity of light transmitted to a front surface side by improving the utilization efficiency of backlight and that can reduce stress experienced by a viewer by reducing glare on a back surface side. Not only a first polarization wave emitted from a light guide plate 20 to a display surface side but also a first polarization wave included in light converted, by a polymer-dispersed liquid-crystal element 60 in a scattering mode from a first polarization wave and a second polarization wave emitted to a rear surface side is converted to a second polarization wave by a liquid-crystal panel 30 and is transmitted to the front surface side. Thus, the utilization efficiency of the light emitted from the light guide plate 20 improves. In addition, a portion of the first polarization wave and the second polarization wave emitted from the light guide plate 20 to the rear surface side is reflected by a reflective polarization plate 53 to the display surface side, and thus the quantity of light of the first polarization wave transmitted to the back surface side is reduced.

### DESCRIPTION

### Technical Field

The present invention relates to display devices and, in particular, relates to a display device that functions as a see-through display as well which allows a background to be seen therethrough.

### Background Art

In recent years, actively being developed are display devices that not only display images based on externally supplied image signals but also function as displays which allow a back surface side to be seen therethrough from a front surface side (hereinafter, referred to as “see-through displays” in some cases). Various systems are employed in such see-through displays, including a system in which a liquid-crystal panel is used, a system in which a transparent organic EL (Organic Light-Emitting Diode) and an ITO (Indium Tin Oxide) thin film, which is a transparent metal, are combined, and a projector system.

The liquid-crystal display device module described in PTL 1 is a see-through display in which reflection and transmission characteristics of a cholesteric liquid crystal are used. This liquid-crystal display device module displays an image by making light incident directly from a backlight unit disposed on a side surface of a liquid-crystal panel; thus, the visibility of the image is improved, and the transparency of the liquid-crystal panel obtained when the liquid-crystal display device module is used as a see-through display is improved.

In the display device described in PTL 2, a backlight unit is disposed between two liquid-crystal cells to irradiate the liquid-crystal cells with backlight, and reflective polarization plates are affixed to the two respective sides of the backlight unit. Thus, the display device can display a bright image on the two liquid-crystal cells. In addition, since the two liquid-crystal panels are irradiated simultaneously by a single backlight unit, the number of the backlight units can be reduced, and the power consumption can be reduced.

### CITATION LIST

### Patent Literature

PTL 1: Japanese Unexamined Patent Application Publication No. 2013-20256

PTL 2: Japanese Unexamined Patent application Publication No. 2004-199027

### SUMMARY OF INVENTION

### Technical Problem

However, in a see-through display of a system in which a liquid-crystal panel is used, for example, an optical member with high transparency needs to be disposed within the display device in order to make the back surface side more easily visible. Disposing such an optical member leads to an increase in the light transmitted to the back surface side, which thus leads to a decrease in the light, of the light emitted from a light guide plate, that is transmitted to the front surface side. Therefore, the utilization efficiency of the light emitted from the light guide plate decreases. Although it depends on the method of extracting light from the light guide plate, the light emitted from the rear surface of the display device toward the back surface side often has a peak in a specific angular direction relative to the light guide plate. Therefore, when a viewer present at the back surface side sees the rear surface of the display device in the specific angular direction, the viewer's eyes are hit by the brightest light, and the viewer is more likely to experience stress.

In the liquid-crystal display device module described in PTL 1, an equal quantity of light is emitted to the front surface side and the back surface side of the liquid-crystal panel, and the light emitted to the back surface side cannot be reused. Therefore, the utilization efficiency of the light incident on the liquid-crystal panel from the backlight unit decreases. In the display device described in PTL 2, the reflective polarization plates on the two sides of the light guide plate are affixed such that their reflection axes are orthogonal to each other. Therefore, this display device cannot be used as a see-through display that allows the back surface side to be seen therethrough from the front surface side.

Accordingly, the present invention is directed to providing a display device that can increase the quantity of light transmitted to a front surface side by improving the utilization efficiency of backlight and that can reduce stress to be experienced by a viewer by suppressing glare on a back surface side.

### Solution to Problem

A first aspect provides a display device including a display that displays an image based on an image signal and that also functions as a see-through display.

The display includes a light source that emits light including a first polarization wave and a second polarization wave, the second polarization wave having a polarization axis orthogonal to a polarization axis of the first polarization wave, a light guide plate that emits the light from the light source toward a display surface side and a rear surface side of the display,

a light scattering switching element disposed on a rear surface of the light guide plate, the light scattering switching element having a transmitting mode in which the

light scattering switching element outputs an incident polarization wave without converting a polarization state of the incident polarization wave and a scattering mode in which the light scattering switching element carries out a conversion to cause a ratio of the first polarization wave and the second polarization wave to approach 1:1 and outputs the first polarization wave and the second polarization wave,

a reflective polarization plate disposed on a rear surface of the light scattering switching element, and

a first polarization plate, a polarization modulating element, and a second polarization plate that are disposed in this order from the light guide plate toward the front surface side,

wherein the polarization modulating element includes a plurality of pixels to which a voltage can be applied, controls a polarization state of the first polarization wave or the second polarization wave incident on the pixels with the voltage, and outputs the first polarization wave or the second polarization wave, and

wherein the reflective polarization plate and the first polarization plate transmit one polarization wave of the first polarization wave and the second polarization wave, and the second polarization plate transmits the other polarization wave.

In a second aspect, in the first aspect,

the first polarization plate and the second polarization plate are both absorptive polarization plates.

In a third aspect, in the first aspect,

the first polarization plate is as absorptive polarization plate, and the second polarization plate is a reflective polarization plate.

In a fourth aspect, in the first aspect,

the first polarization plate is a reflective polarization plate, and the second polarization plate is an absorptive polarization plate.

In a fifth aspect, in any one of the second to fourth aspects,

the polarization modulating element is a liquid-crystal panel.

In a sixth aspect, in the fifth aspect,

the liquid-crystal panel is a normally white panel.

In a seventh aspect, in the fifth aspect,

the liquid-crystal panel is a panel of a twisted nematic system.

In an eighth aspect, in the first aspect,

a color filter disposed between the polarization modulating element and the second polarization plate is further provided.

In a ninth aspect, in the first aspect,

the light source includes a plurality of types of light-emitting bodies that emit light that can express at least white and causes the plurality of light-emitting bodies to emit light successively in time division.

In a tenth aspect, in the first aspect,

the light scattering switching element enters the scattering mode when an electric field is turned on and enters the transmitting mode when the electric field is turned off.

In an eleventh aspect, in the tenth aspect,

the light scattering switching element includes a liquid-crystal layer, a polymer network formed within the liquid-crystal layer, and a sealing member having an electrode formed on a surface thereof, the lightscattering switching element being a polymer-dispersed liquid-crystal element having a structure in which the liquid-crystal layer and the polymer-dispersed liquid-crystal element are sandwiched by the sealing member.

In a twelfth aspect, in the eleventh aspect,

the sealing member of the light scattering switching element is either an isotropic film sheet or an isotropic glass plate.

### Advantageous Effects of Invention

According to the first aspect, not only one of the polarization waves emitted from the light guide plate to the display surface side but also one of the polarization waves included in the light converted, by the light scattering switching element in the scattering mode, from the first polarization wave and the second polarization wave emitted to the rear surface side is converted to the other polarization wave by the polarization modulating element and transmitted to the front surface side. Thus, the utilization efficiency of the light emitted from the light guide plate improves and the screen becomes brighter. In addition, a portion of the first polarization wave and the second polarization wave emitted from the light guide plate to the rear surface side is reflected by the reflective polarization plate to the display surface side, and thus the quantity of light of the one polarization wave transmitted to the back surface side is reduced. Thus, any stress associated with glare experienced by a viewer present at the back surface side is relieved.

According to the second aspect, similarly to the case of the first invention, the light utilization efficiency can be improved, and the quantity of light of the polarization wave transmitted to the back surface side can be reduced. In addition, when the display is used as a see-through display, since the quantity of light of the polarization wave transmitted to the front surface side or the back surface side is reduced, the brightness of the screen seen by the viewer is reduced, but the viewer can see the background displayed clearly without any blur because of the reduced turbidity of the light guide plate.

According to the third aspect, an advantageous effect similar to that in the case of the first invention is obtained. In addition, when the display is used as a see-through display, an advantageous effect similar to that of the second invention is obtained. Furthermore, the reflective polarization plate disposed on the front surface of the display functions as a mirror that reflects the first polarization wave incident from the front surface side, and thus a well-designed display can be achieved

According to the fourth aspect, an advantageous effect similar to that in the case of the first invention is obtained. In addition, when the display i used as a see-through display, an advantageous effect similar to that of the second invention is obtained.

According to the fifth aspect, since the polarization modulating element is a liquid-crystal panel, the polarization state of the incident light can be controlled with ease.

According to the sixth aspect, since the polarization modulating element is a normally white liquid-crystal panel, the display functions as a see-through display while the power source of the liquid-crystal panel is in an off state, and a viewer can see the state of the back surface side or the state of the front surface side.

According to the seventh aspect, since the liquid-crystal panel, serving as the polarization modulating element, is of a twisted nematic system, a conversion between the first polarization wave and the second polarization wave can be carried out with ease.

According to the eighth aspect, as the color filter is provided between the polarization modulating element and the second polarization plate, the light transmitted from the back surface side or the front surface side or the light emitted from the light guide plate to the front surface side is transmitted through the color filter. Thus, a viewer present at the front surface side can see a color image or see the state of the back surface side or the front surface side in color.

According to the ninth aspect, by irradiating the polarization modulating element successively in time division with the light in colors that can express at least white, a viewer present at the front surface side can see a color image or see the state of the back surface side in color. Furthermore, since no color filter needs to be provided, absorption of the light by a color filter does not occur, and the image or the state of the back surface can be displayed with a higher luminance.

According to the tenth aspect, the use of the reverse-mode light scattering switching element that enters the transmitting mode when the electric field is turned off allows the display to function as a see-through display while the power source of the display is being turned off. Thus, the power consumed by the display functioning as a see-through display can be reduced.

According to the eleventh aspect, since the light scattering switching element is a polymer-dispersed liquid-crystal element having a structure in which the liquid-crystal layer and the polymer network formed within the liquid-crystal layer are sandwiched by the sealing members, a switch between the transmitting mode and the scattering mode can be made with ease.

According to the twelfth aspect, an isotropic film sheet or an isotropic glass plate is used as the sealing member of the light scattering switching element to suppress birefringence at the sealing member. Thus, a decrease in the quantity of transmitted light transmitted through the light scattering switching element can be prevented; thus, the light utilization efficiency improves, and the screen becomes brighter.

### BRIEF DESCRIPTION OF DRAWINGS

FIG. 1 illustrates light ray trajectories obtained when light incident from a back surface side is transmitted to a front surface side in a display used in a first base study.

FIG. 2 illustrates light ray trajectories obtained when light incident from the front surface side is transmitted to the back surface side in the display illustrated in FIG. 1.

FIG. 3 illustrates light ray trajectories obtained when light emitted from a light guide plate while a light source is being turned on is transmitted to the front surface side and the back surface side in the display illustrated in FIG. 1.

FIG. 4 illustrates light ray trajectories obtained when light incident from a back surface side is transmitted to a front surface side in a display used in a second base study.

FIG. 5 illustrates light ray trajectories obtained when light incident from the front surface side is transmitted to the back surface side in the display illustrated in FIG. 4.

FIG. 6 illustrates light ray trajectories obtained when light emitted from a light guide plate while a light source is being turned on is transmitted to the front surface side and the back surface side in the display illustrated in FIG. 4.

FIG. 7 illustrates a relationship between the turbidity of a light guide plate and how a background is seen or the brightness of a screen. To be more specific (A) illustrates a relationship between the turbidity and how the background is seen or the brightness of the screen when the turbidity is high, and (B) illustrates how the background is seen and the brightness of the screen when the turbidity is low.

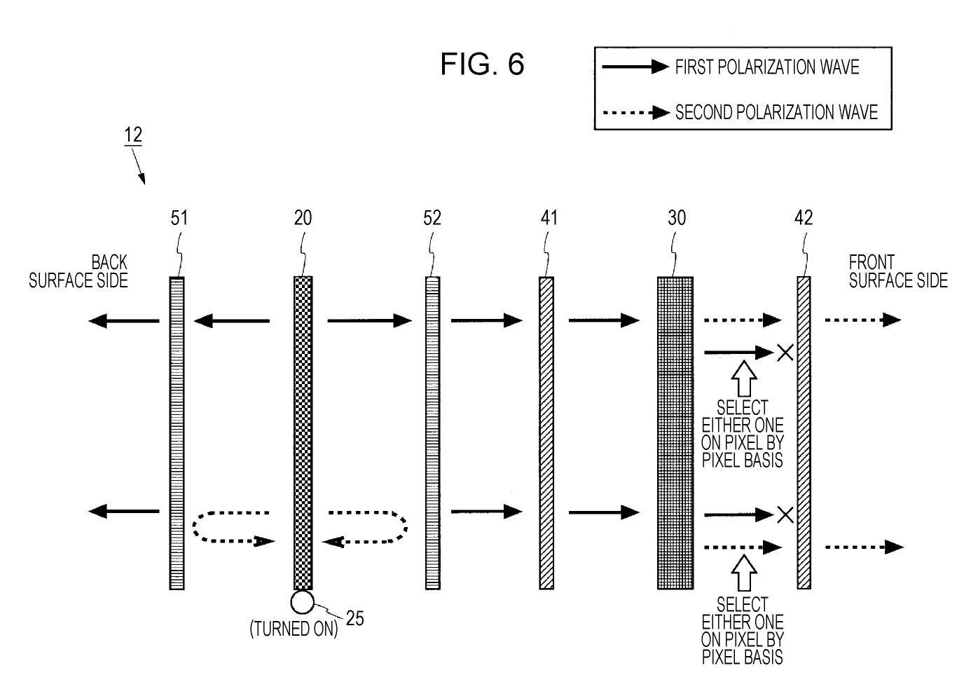

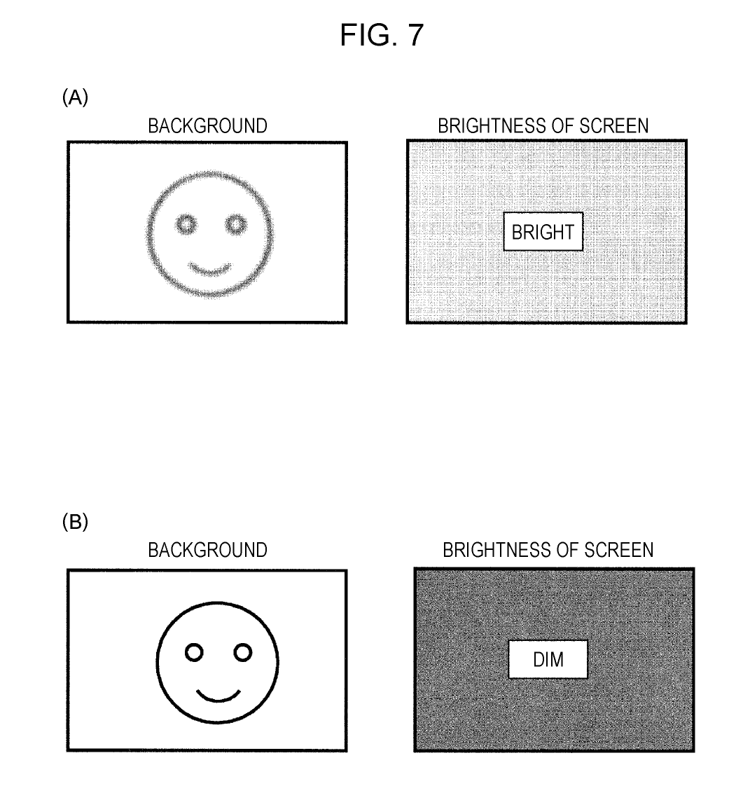

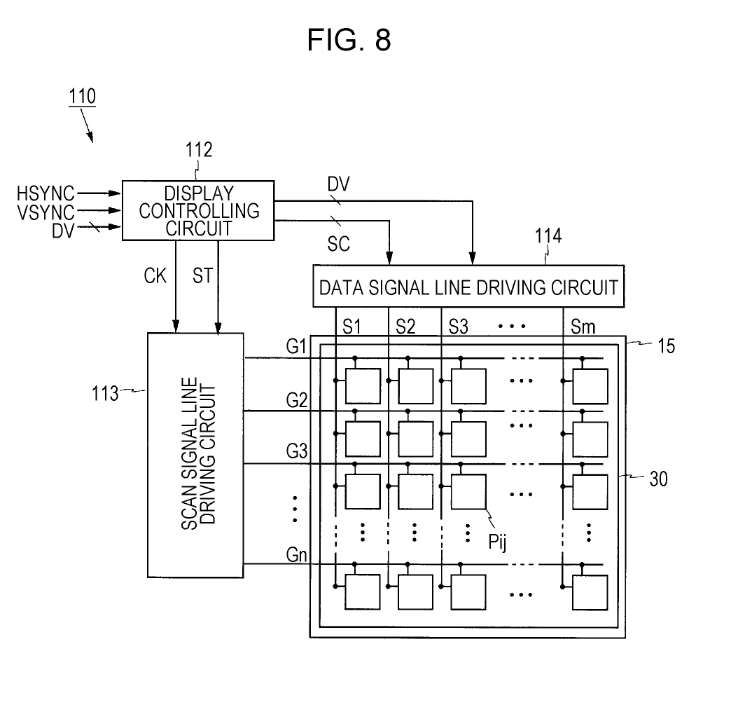

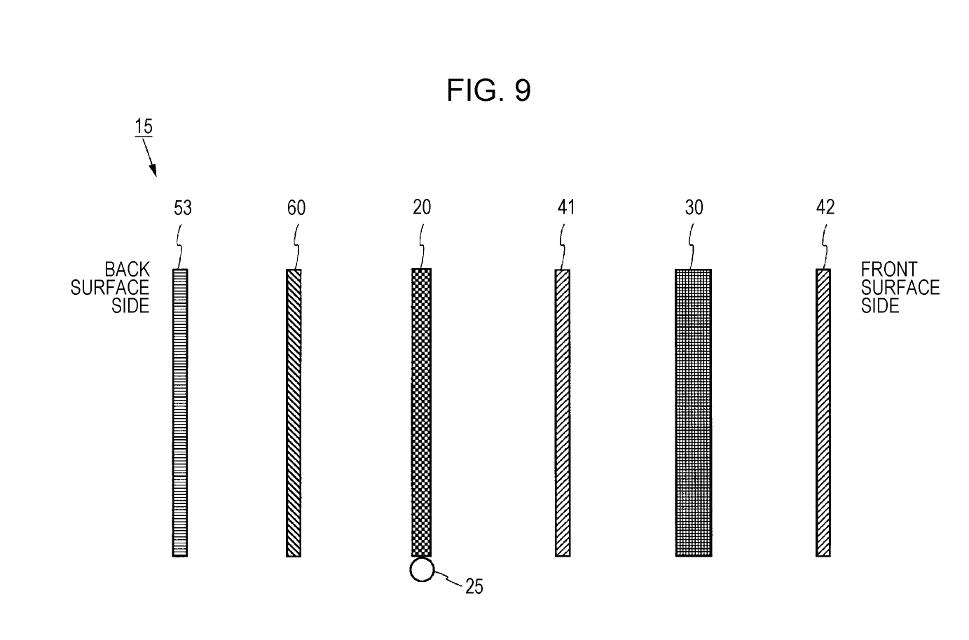

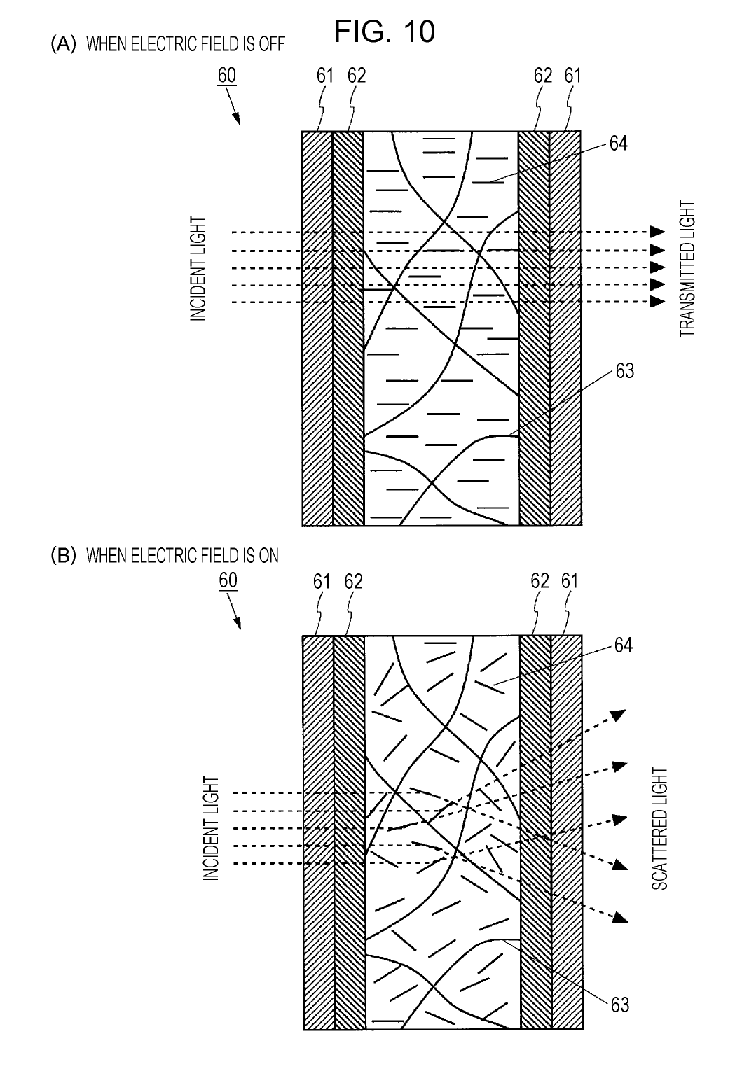

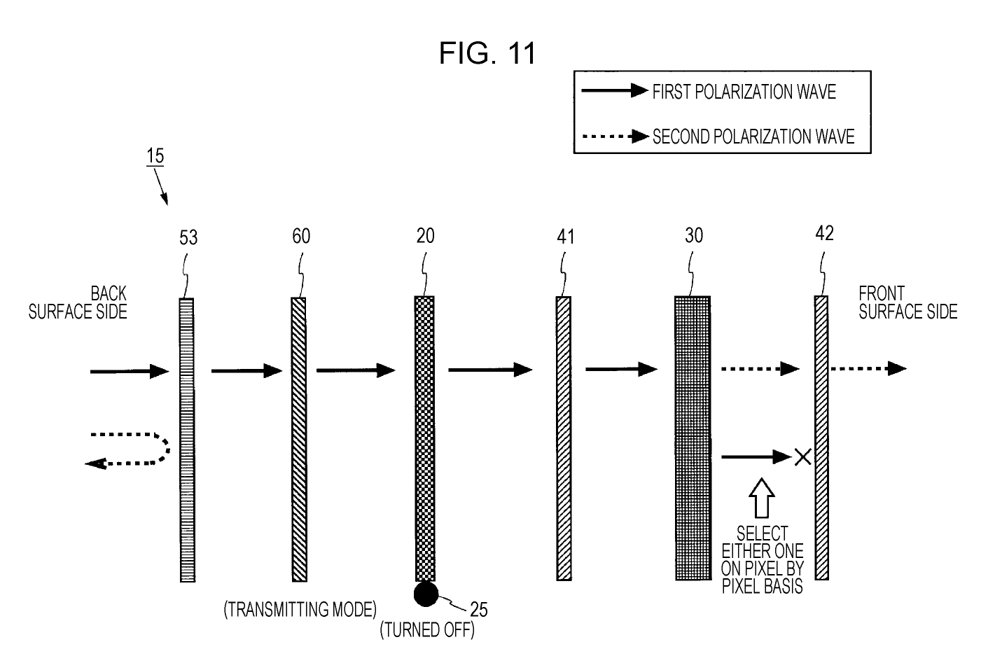

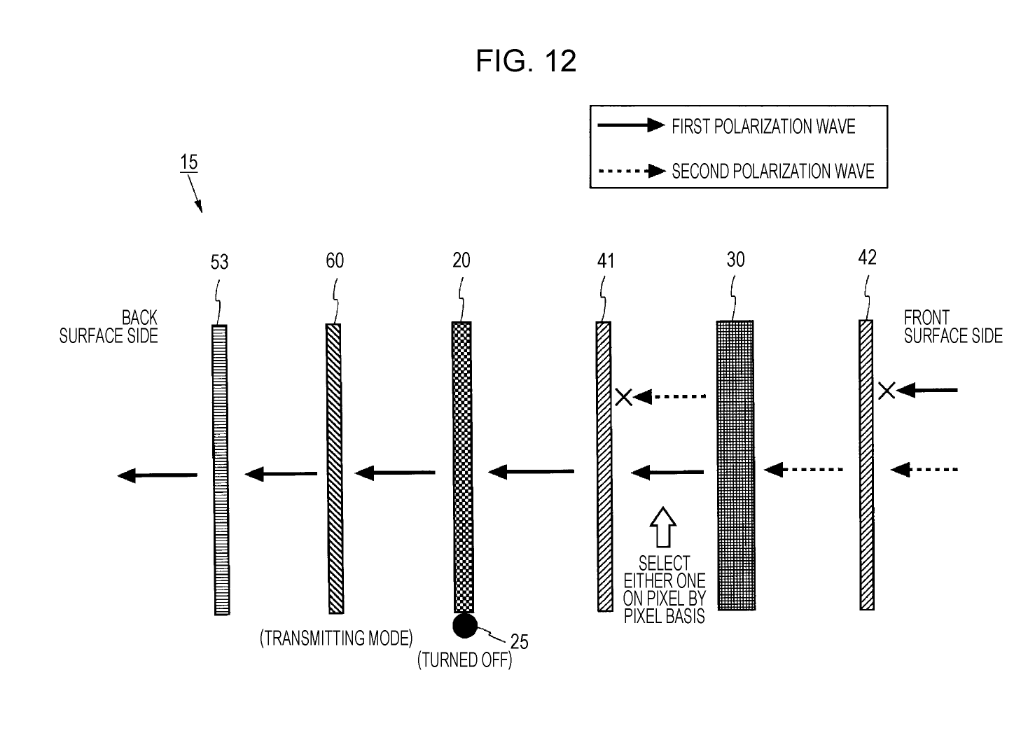

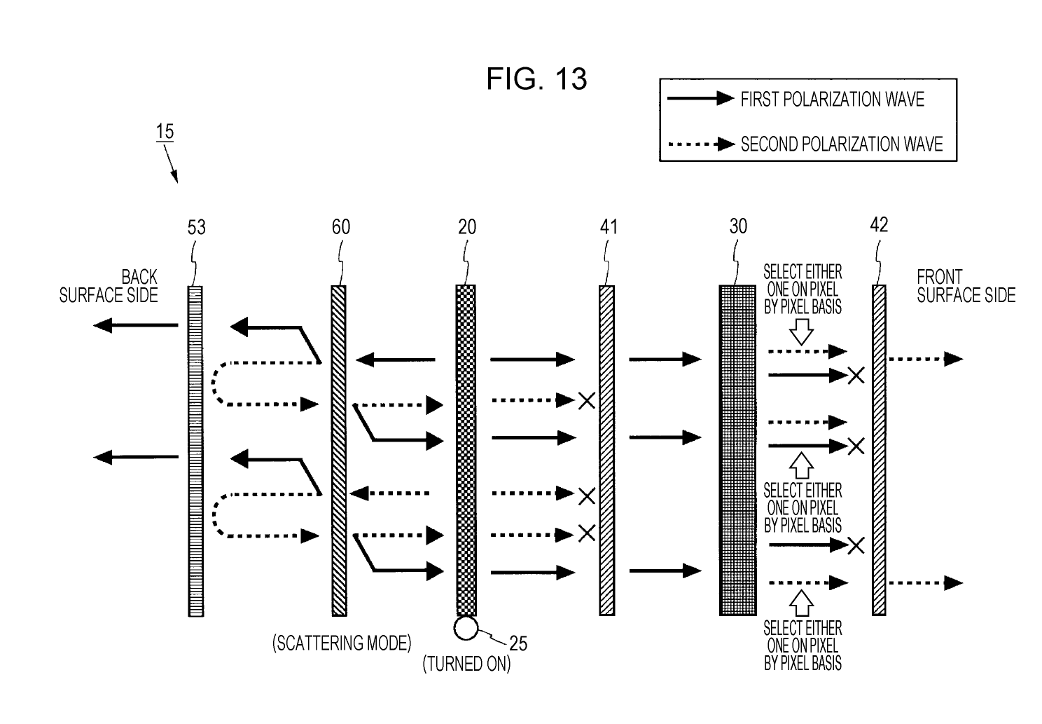

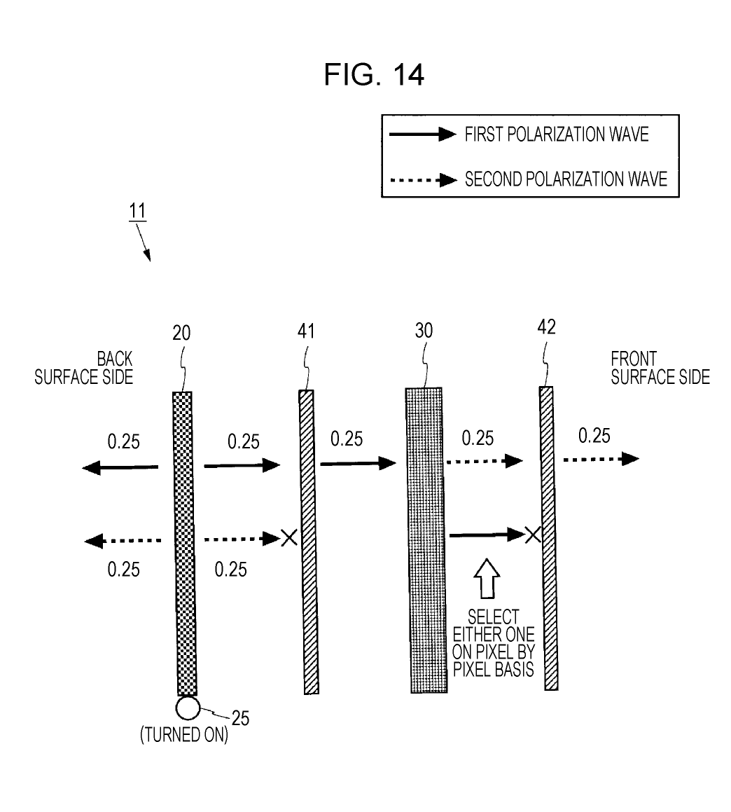

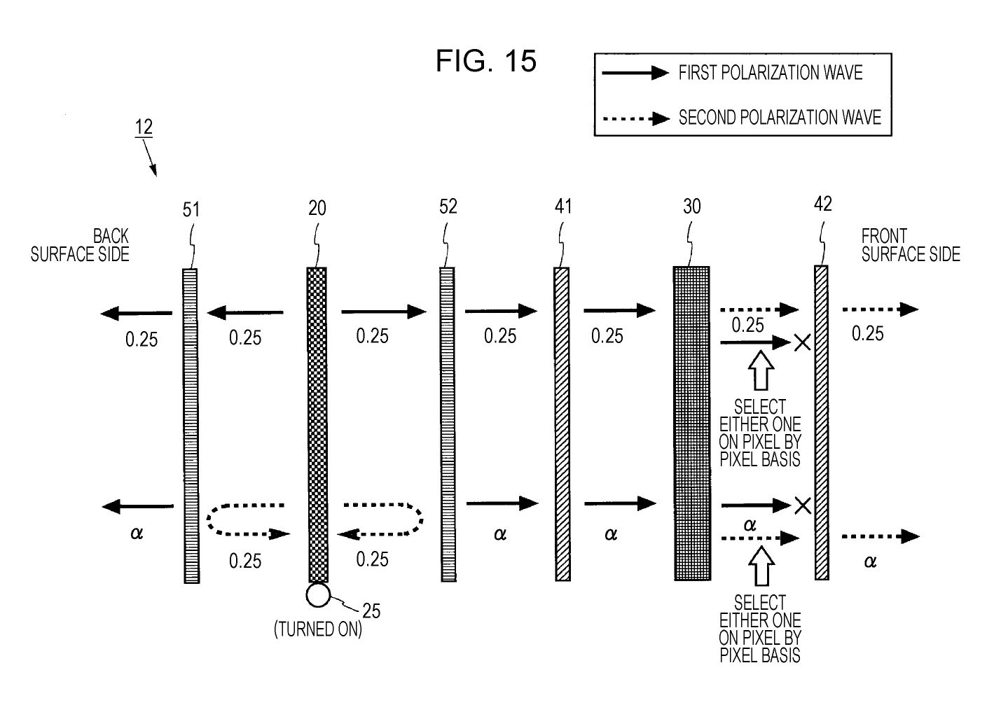

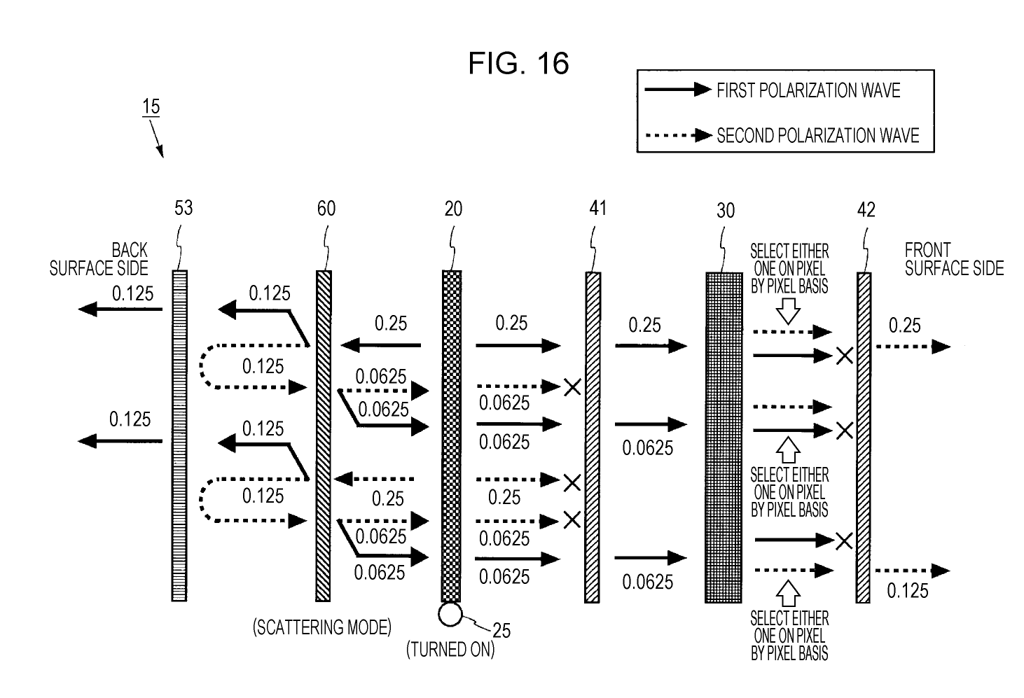

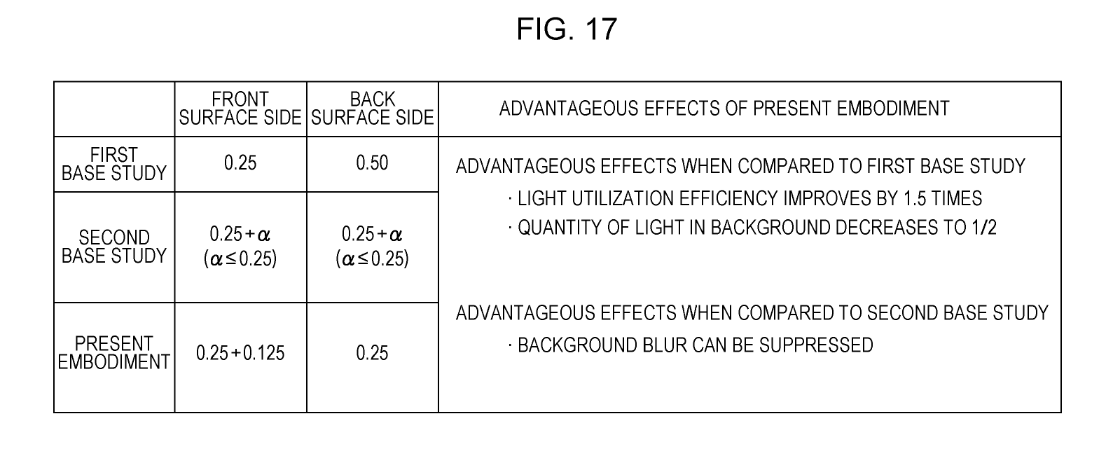

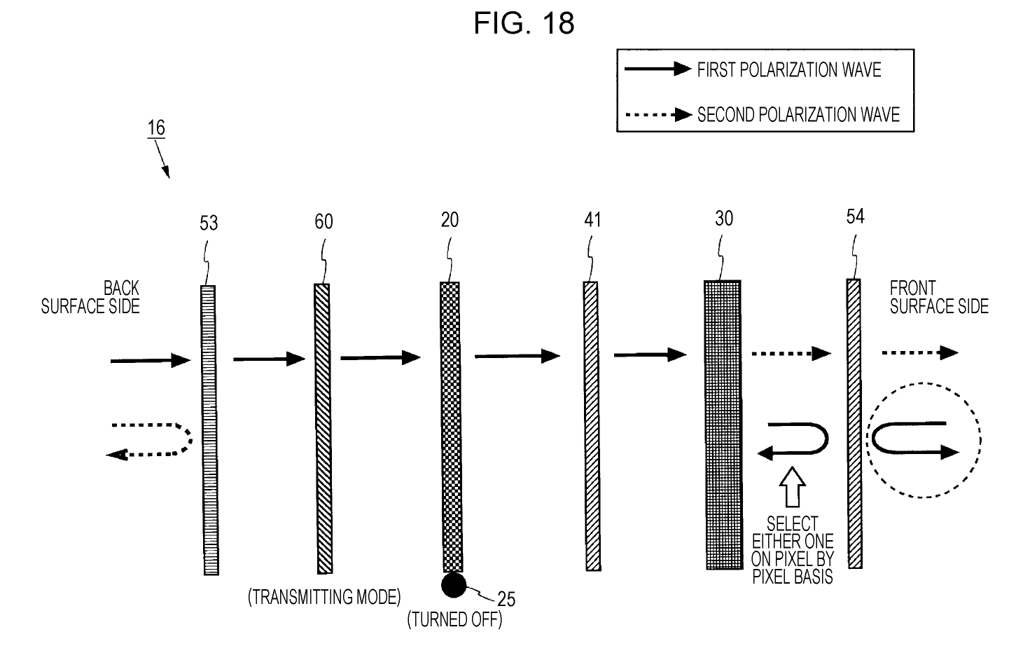

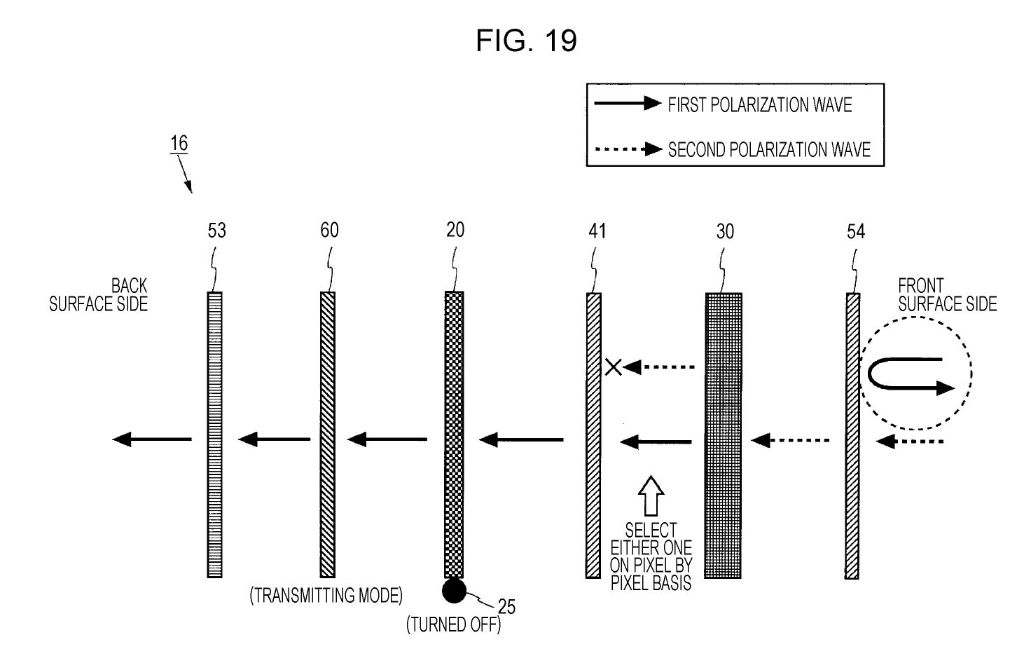

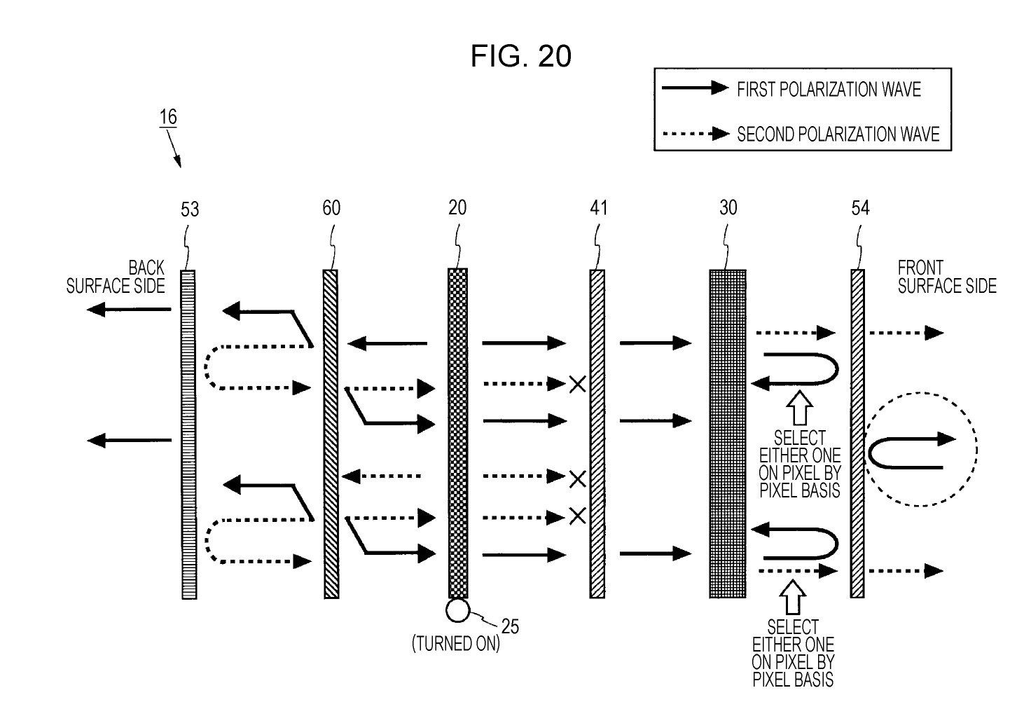

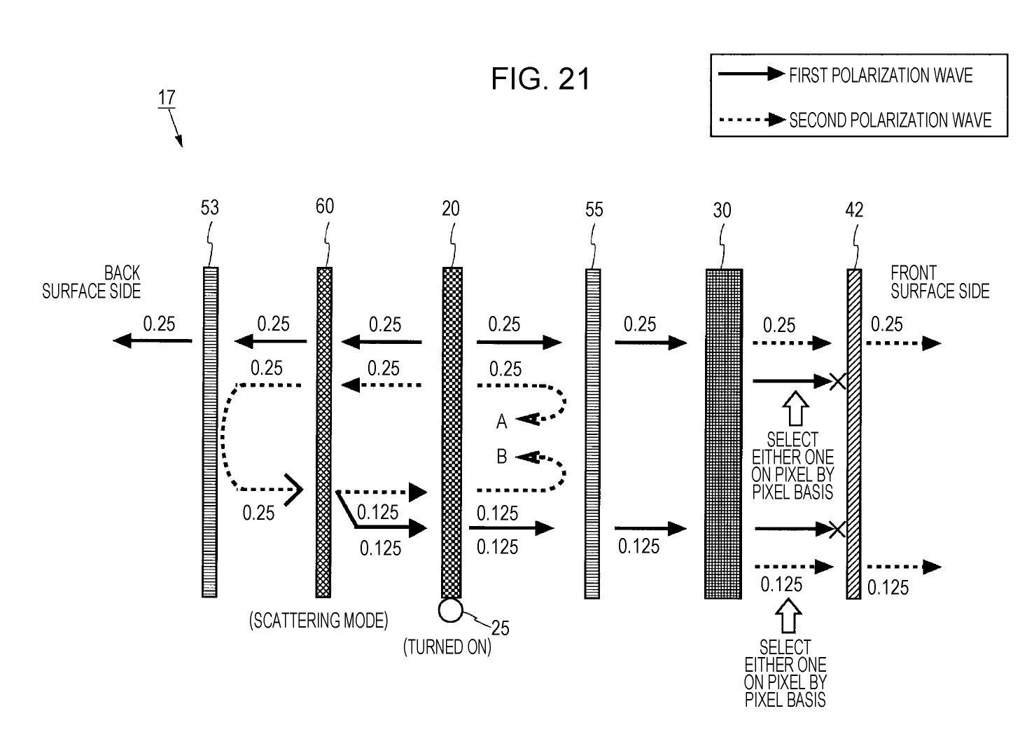

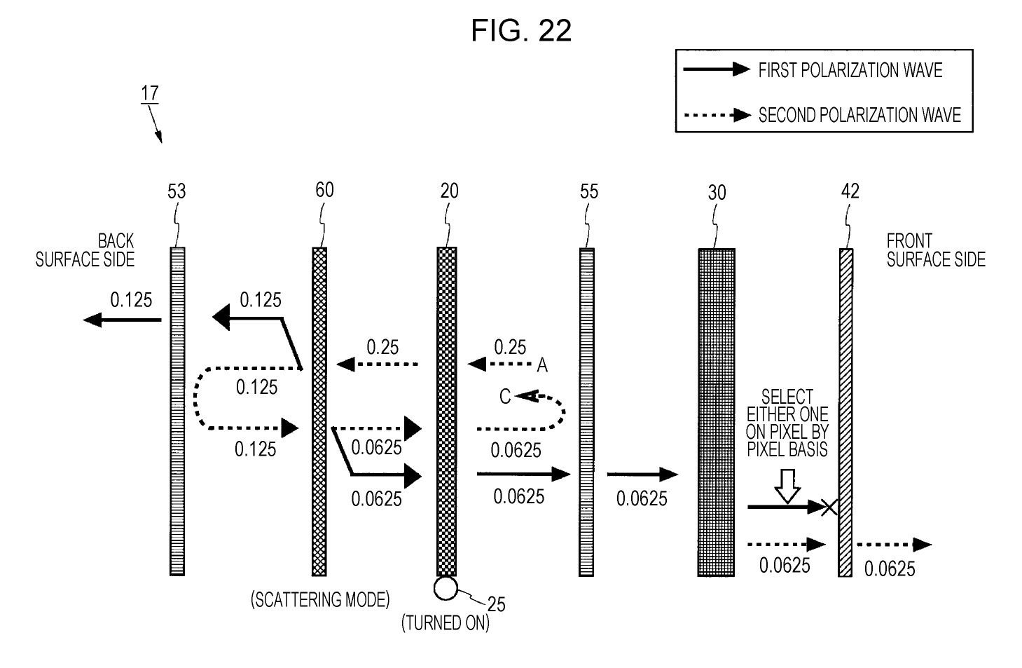

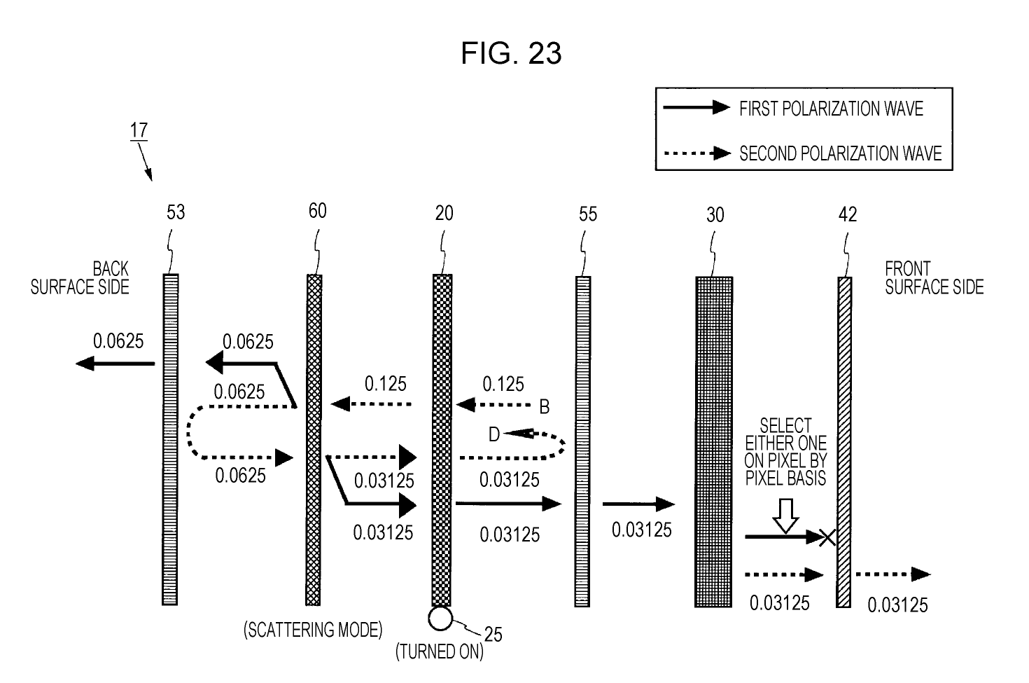

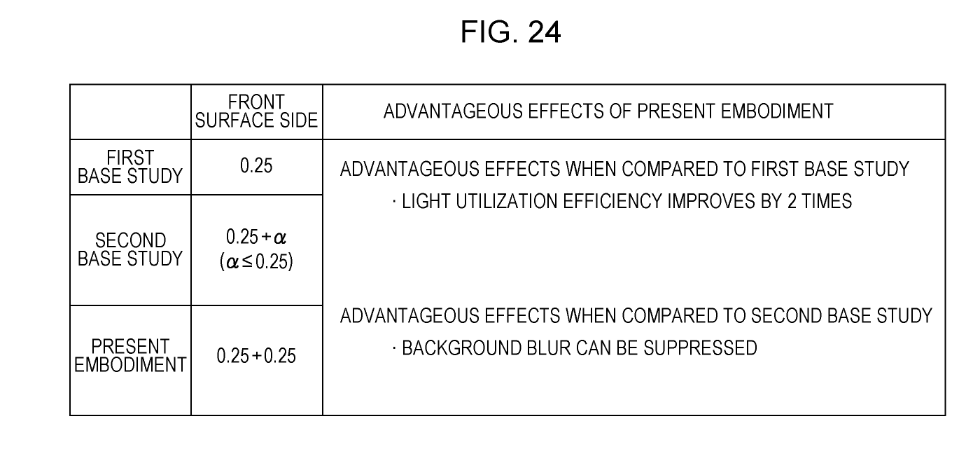

FIG. 6 is a block diagram illustrating a configuration of a liquid-crystal display device according to a first embodiment.

FIG. 9 is a sectional view illustrating a configuration of a display included in the liquid-crystal display device according to the first embodiment.

FIG. 10 is a sectional view illustrating a configuration of a polymer-dispersed liquid-crystal element that adjusts the proportions of a first polarization wave and a second polarization wave. To be more specific, (A) is a sectional view of the polymer-dispersed liquid-crystal element that has entered a transmitting mode upon an electric field being turned on, and (B) is a sectional view of the polymer-dispersed liquid-crystal element that has entered a scattering mode upon the electric field being turned off.

FIG. 11 illustrates light ray trajectories obtained when light incident from a back surface side is transmitted to a front surface side in the display illustrated in FIG. 9.

FIG. 12 illustrates light ray trajectories obtained when light incident from the front surface side is transmitted to the back surface side in the display illustrated in FIG. 9.

FIG. 13 illustrates light ray trajectories obtained when light emitted from a light guide plate while a light source is being turned on is transmitted to the front surface side and the back surface side in the display illustrated in FIG. 9.

FIG. 14 illustrates light ray trajectories and the quantities of light in the light ray trajectories in the display used in the first base study.

FIG. 15 illustrates light ray trajectories and the quantities of light in the light ray trajectories in the display used in the second base study.

FIG. 16 illustrates a relationship between the light ray trajectories and the quantities of light in the display according to the first embodiment.

FIG. 17 illustrates a summary of advantageous effects of the first embodiment in comparison to those in the cases of the first and second base studies.

FIG. 18 illustrates light ray trajectories obtained when light incident from a back surface side is transmitted to a front surface side in a display according to a second embodiment.

FIG. 19 illustrates light ray trajectories obtained when light incident from the front surface side is transmitted to the back surface side in the display according to the second embodiment.

FIG. 20 illustrates light ray trajectories obtained when light emitted from a light guide plate while a light source is being turned on is transmitted to the front surface side and the back surface side in a second display.

FIG. 21 illustrates, in time series, light ray trajectories of first and second polarization waves emitted from a light guide plate and the quantities of light in the light ray trajectories in a display according to a third embodiment.

FIG. 22 illustrates, in time series continuing from FIG. 21, the light ray trajectories of the first and second polarization waves emitted from the light guide plate and the quantities of light in the light ray trajectories in the display according to the third embodiment.

FIG. 23 illustrates, in time series continuing from FIG. 22, the light ray trajectories of the first and second polarization waves emitted from the light guide plate and the quantities of light in the light ray trajectories in the display according to the third embodiment.

FIG. 24 illustrates a summary of advantageous effects of the third embodiment in comparison to those in the cases of the first and second base studies.

FIG. 25 is an illustration for describing light ray trajectories of light transmitted from a back surface side to a front surface side in a state in which a film or a glass plate that exhibits birefringence is used as a sealing member of a polymer-dispersed lipoid-crystal element and a light source is not being turned on according to a fifth embodiment.

FIG. 26 is an illustration for describing light ray trajectories of light emitted from the light guide plate in a state in which a film or a glass plate that exhibits birefringence is used as a sealing member of a polymer-dispersed liquid-crystal element and the light source is being turned on according to the fifth embodiment.

FIG. 27 is a sectional view illustrating a configuration of a display of a color filter type that displays an image and a background in color.

### DESCRIPTIONS OF EMBODIMENTS

### 1. Base Studies

Prior to describing embodiments, first and second base studies conducted by the inventor to clarify the problems of a conventional liquid-crystal display device that functions as a see-through display will be described.

### <1.1 First Base Study>

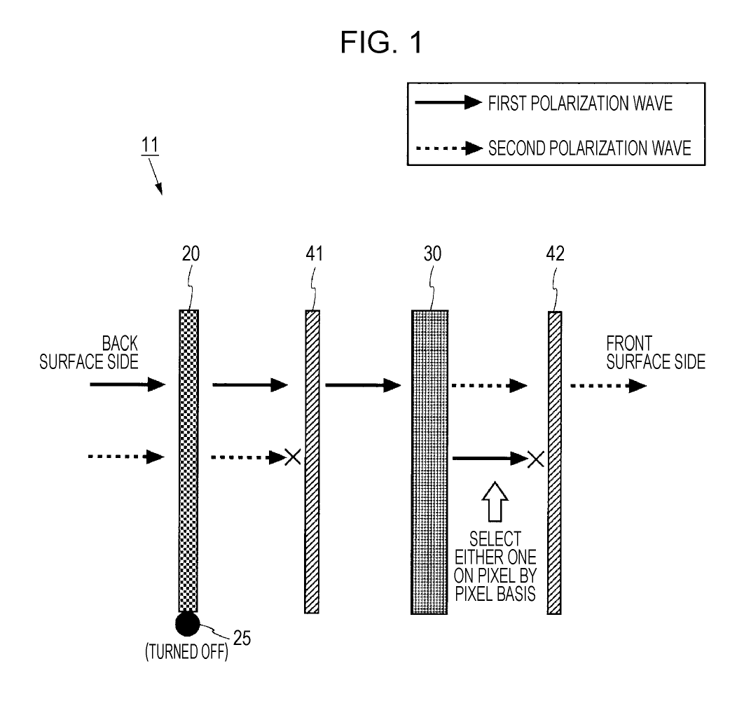

FIG. 1 illustrates light ray trajectories obtained when light incident from a back surface side is transmitted to a front surface side in a display 11 used in the first base study. As illustrated in FIG. 1, in the display 11, a second absorptive polarization plate 42, a liquid-crystal panel 30, a first absorptive polarization plate 41, and a light guide plate 20 are disposed from the front surface side toward the back surface side. The liquid-crystal panel 30 is a normally white panel that is driven in a TN (Twisted Sematic) system.

Since the liquid-crystal panel 30 is driven in a TN system, each pixel in the liquid-crystal panel 30 rotates, by 90 degrees, the polarization axis of a polarization wave incident while in a non-driven state (off state) and outputs the resultant polarization wave. The non-driven state is either a state in which a signal voltage corresponding to an image signal DV is not being written or a state in which a signal voltage of 0 V is being written. Upon entering a driven state (on state) in which a maximum signal voltage is written, the liquid-crystal panel 30 outputs a polarization wave as-is without rotating the polarization axis thereof. When a voltage value of a written signal voltage is an intermediate value of the aforementioned two, a polarization wave having its polarization axis rotated by 90 degrees and a polarization wave without having its polarization axis rotated are output at a ratio corresponding to the voltage value.

In the display 11, the first absorptive polarization plate 41 is disposed at a rear surface side of the liquid-crystal panel 30, and the second absorptive polarization plate 42 having a transmission axis orthogonal to the transmission axis of the first absorptive polarization plate 41 is disposed at a display surface side. Therefore, a first polarization wave incident on an off-state pixel has its polarization axis rotated upon passing through the pixel to result in a second polarization wave and is transmitted through the second absorptive polarization plate 42 to exit to the front surface side. Meanwhile, a first polarization wave incident on an on-state pixel is output as-is and absorbed by the second absorptive polarization plate 42. In the drawings illustrating the light ray trajectories in the present application, “x” is appended at the head of an arrow indicating the traveling direction of a polarization wave absorbed by an absorptive polarization plate.

With reference to FIG. 1, light ray trajectories of light incident from the back surface side while a light source 25 attached to the light guide plate 20 is being turned off (off) and the liquid-crystal panel 30 is in a driven state will be described. For example, the light source 25, such as an LED (Light Emitting Device), is attached to an end portion of the light guide date 20, and the light source 25 is being turned off in FIG. 1.

As illustrated in FIG. 1, a first polarization wave and a second polarization wave included in the light incident from the back surface side are transmitted through the light guide plate 20 and become incident on the first absorptive polarization plate 41. The first polarization wave is transmitted through the first absorptive polarization plate 41, and the second polarization wave is absorbed thereby. The first polarization wave transmitted through the first absorptive polarization plate 41 is incident on the liquid-crystal panel 30. Since the liquid-crystal panel 30 is of a TM system, of the first polarization wave incident on the liquid-crystal panel 30, the first polarization wave incident on an off-state pixel has its polarization axis rotated by the liquid-crystal panel 30 to be converted into the second polarization wave and is then emitted. The first polarization wave incident on an on-state pixel is emitted as-is as the first polarization wave without having its polarization axis rotated. The second polarization wave emitted from the liquid-crystal panel 30 is transmitted through the second absorptive polarization plate 42, and the first polarization wave is absorbed by the second absorptive polarization plate 42. Thus, only the second polarization wave that has been transmitted through off-state pixels is transmitted to the front surface side. As a result, a viewer present at the front surface side can see a screen in which a state of the back surface side is displayed at positions corresponding to the off-state pixels and black display appears at positions corresponding to the on-state pixels.

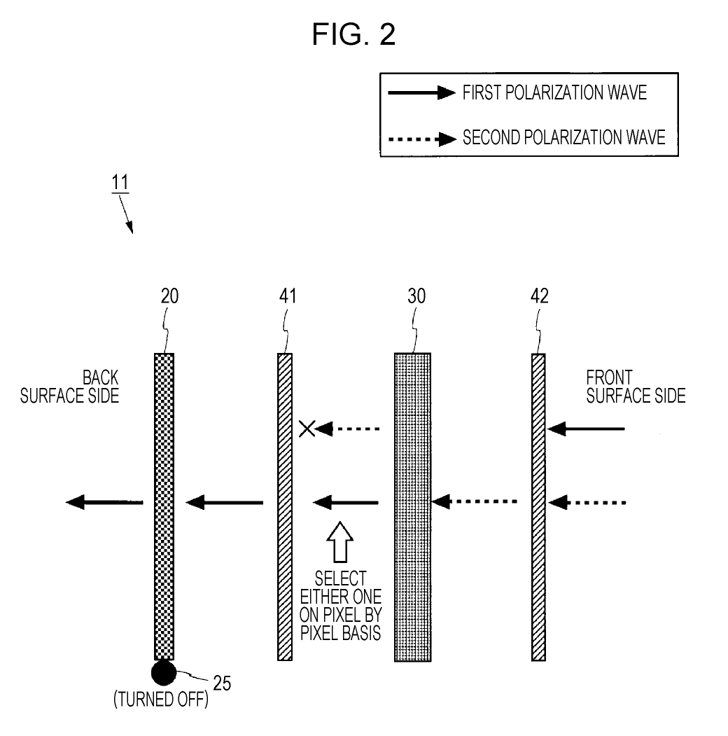

FIG. 2 illustrates light ray trajectories obtained when light incident from the front surface side is transmitted to the back surface side in the display 11 illustrated in FIG. 1. With reference to FIG. 2, light ray trajectories obtained when light is incident from the front surface side while the light source 25 attached to the end portion of the light guide plate 20 is being turned off and the liquid-crystal panel 30 is in a driven state will be described. As illustrated in FIG. 2, of the light incident on the second absorptive polarization plate 42 from the front surface side, the first polarization wave is absorbed by the second absorptive polarization plate 2, and the second polarization wave is transmitted through the second absorptive polarization plate 42 to become incident on the liquid-crystal panel 30. Of the second polarization wave incident on the liquid-crystal panel 30, the second polarization wave incident on an on-state pixel is emitted as-is as the second polarization wave without having its polarization axis rotated by tie liquid-crystal panel 30. The second polarization wave incident on an off-state pixel has its polarization axis rotated to be converted into the first polarization wave and is then emitted. These polarization waves are incident on the first absorptive polarization plate 41, the first polarization wave is transmitted through the first absorptive polarization plate 41, and the second polarization wave is absorbed by the first absorptive polarization plate 41. The first polarization wave is transmitted through the light guide plate 20 to exit to the back surface side. As a result, a viewer present at the back surface side can see a state in which a state of the front surface side is displayed at positions corresponding to the off-state pixels and black display appears at positions corresponding to the on-state pixels. In this manner, the light ray trajectories illustrated in FIG. 1 and FIG. 2 reveal that the display 11 functions as a see-through display.

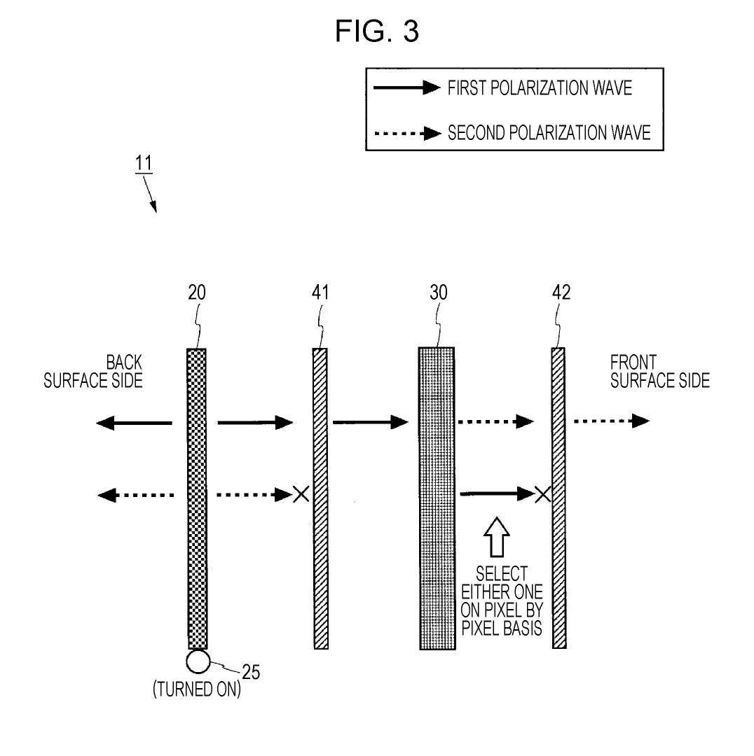

FIG. 3 illustrates light ray trajectories obtained when light emitted from the light guide plate 20 while the light source 25 is being turned on is transmitted to the front surface side and the back surface side in the display 11 illustrated in FIG. 1. With reference to FIG. 3, light ray trajectories of light emitted from the light source 25 while the light source 25 attached to the light guide plate 20 is being turned on (on) and the liquid-crystal panel 30 is in a driven state will be described. The light emitted from the light source 25 includes the first polarization wave and the second polarization wave. Upon entering the light guide plate 20, the light travels while undergoing total reflection inside the light guide plate 20 and is emitted from the light guide plate 20 to the display surface side and the back surface side of the display 11. As illustrated in FIG. 3, the firs t polarization wave and the second polarization wave emitted from the light guide slate 20 to the back surface side are transmitted as-is to the back surface side. Therefore, a viewer present at the back surface side experiences glare upon seeing the display 11.

The first polarization wave and the second polarization wave emitted to the display surface side are incident on the first absorptive polarization plate 41. The light ray trajectories from a point where these polarization waves are incident on the first absorptive polarization plate 41 to a point where only the second polarization wave is transmitted to the front surface side are the same as in the case illustrated in FIG. 1, and thus descriptions thereof will be omitted. As a result, a viewer present at the front surface side can see a screen in which a luminous state is displayed an positions corresponding to the off-state pixels and black display appears at positions corresponding to the on-state pixels.

According to the first base study, when the light source 25 is turned on, the first polarization wave included in the light emitted from the light guide plate 20 to the display surface side contributes to the brightness of the screen, but the second polarization wave is absorbed by the first absorptive polarization plate 41 and does not contributed to,the brightness of the screen. In addition, neither of the first and second polarization waves emitted from the light guide plate 20 to the back surface side contributes to the brightness of the screen. In this manner, a large portion of the light emitted from the light source 25 fails to contribute to the brightness of the display surface, which thus poses a problem of low light utilization efficiency. Furthermore, the light emitted from the light guide plate 20 to the back surface side often has a peak of brightness in a specific angular direction relative to the light guide plate 20, although it depends on the structure of the display 11. In this case, if a viewer sees the rear surface of the display 11 in the stated angular direction, the brightness is highest in this direction, which thus poses another problem in that the viewer is more likely to experience stress associated with glare.

### <1.2 Second Base Study>

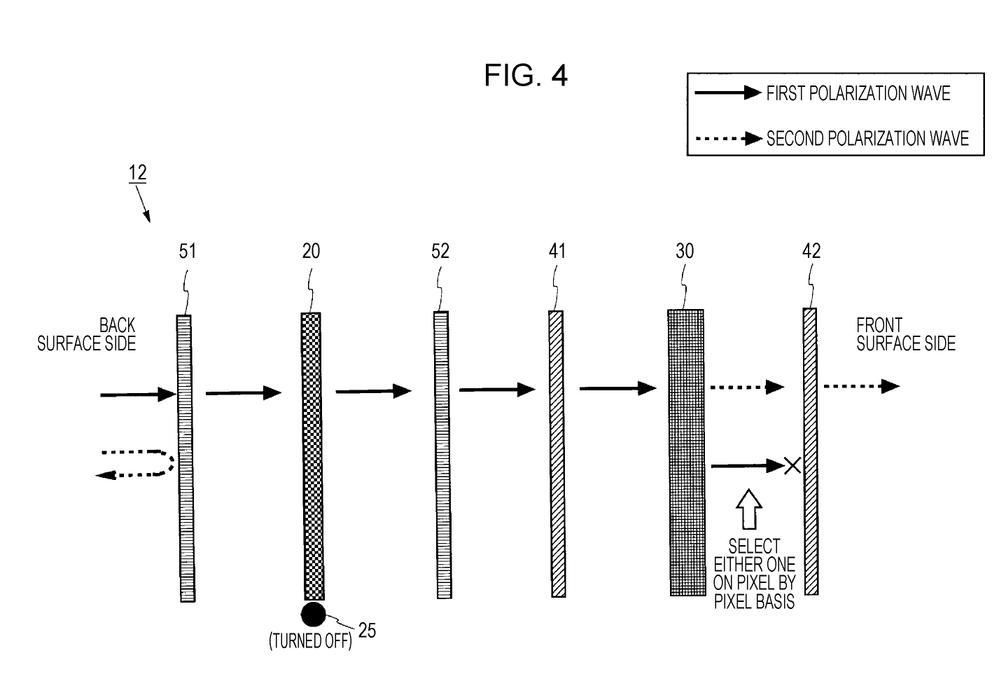

FIG. 4 illustrates light ray trajectories obtained when light incident from a back surface side is transmitted to a front surface side in a display 12 used in the second base study. As illustrated in FIG. 4, in the display 12, a second absorptive polarization plate 42, a liquid-crystal panel 30, a first absorptive polarization plate 41, a second reflective polarization plate 52, a light guide plate 20, and a first reflective polarization plate 51 are disposed from the front surface side toward the back surface side. The liquid-crystal panel 30 is a normally white panel that is driven in a TN system. In this manner, in the display 12, the two first and second reflective polarization plates 51 and 52 that sandwich the light guide plate 20 and that each have a transmission axis in the same direction as the transmission axis of the first absorptive polarization plate 41 are added to the display 11 illustrated in FIG. 1. In this case, the first and second reflective polarization plates 51 and 52 transmit the first polarization wave and reflect the second polarization wave.

With reference to FIG. 4, light ray trajectories of light incident from the back surface side while a light source 25 attached to an end portion of the light guide plate 20 is being turned off and the liquid-crystal panel 30 is in a driven state will be described. The second polarization wave incident on the first reflective polarization plate 51 from the back surface side is reflected by the first reflective polarization plate 51 and directed back to the back surface side.

Since the transmission axes of the first and second reflective polarization plates 51 and 52 are in the same direction as the transmission axis of the first absorptive polarization plate 41, the first polarization wave incident from the back surface side is transmitted successively through the first reflective polarization plate 51, the light guide plate 20, the second reflective polarization plate 52, and the first absorptive polarization plate 41 and becomes incident on the liquid-crystal panel 30. The light ray trajectories of the first polarization wave incident on the liquid-crystal panel 30 are the same as in the case illustrated in FIG. 1 described in the first base study, and thus descriptions thereof will be omitted. Thus, only the first polarization wave transmitted through an off-state pixel is converted to the second polarization wave and transmitted to the front surface side. As a result, a viewer present at the front surface side can see a screen in which a state of the back surface side is displayed at positions corresponding to the off-state pixels and black display appears at positions corresponding to the on-state pixels.

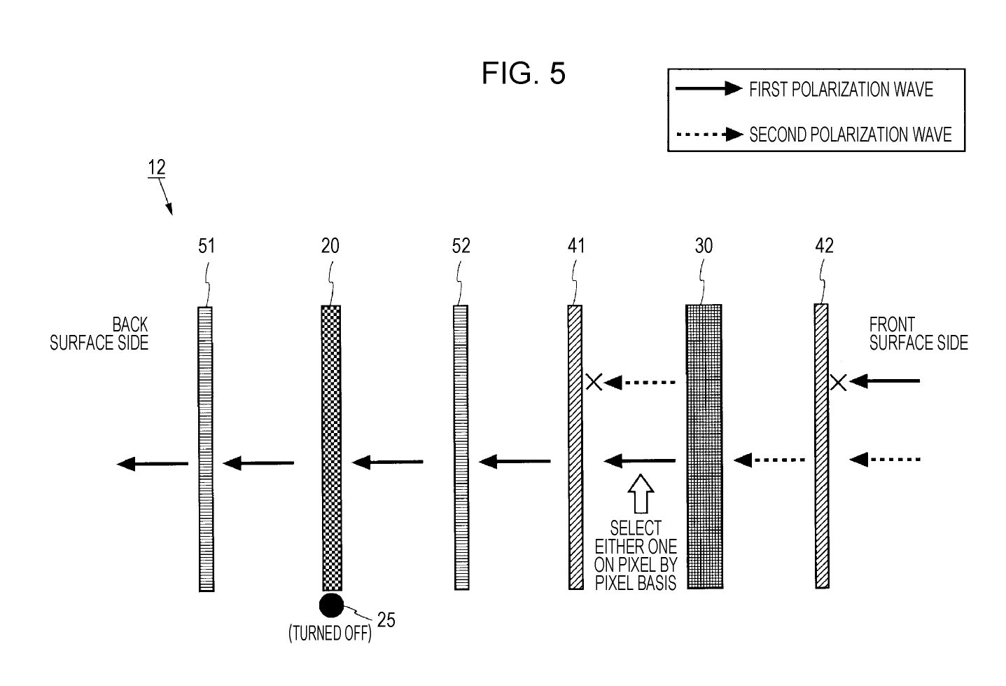

FIG. 5 illustrates light ray trajectories obtained when light incident from the front surface side is transmitted to the back surface side in the display 12 illustrated in FIG. 4. With reference to FIG. 5, light ray trajectories of light incident from the front surface side while the light source 25 attached to the end portion of the light guide plate 20 is being turned off and the liquid-crystal panel 30 is in a driven state will be described. As illustrated in FIG. 5, the first polarization wave incident on the second absorptive polarization plate 42 from the front surface side is absorbed by the second absorptive polarization plate 42, and the second polarization wave is transmitted through the second absorptive polarization plate 42 and becomes incident on the liquid-crystal panel 30. The light ray trajectories of the second polarization wave incident on the liquid-crystal panel 30 are the same as in the case illustrated in FIG. 2 described in the first base study, and thus descriptions thereof will be omitted. Thus, the first polarization wave and the second polarization wave are emitted from the liquid-crystal panel 30 and become incident on the first absorptive polarization plate 41. The first polarization wave is transmitted through the first absorptive polarization plate 41 and becomes incident on the second reflective polarization plate 52, and the second polarization wave is absorbed by the first absorptive polarization plate 41.

Since the transmission axes of the second reflective polarization plate 52 and the first reflective polarization plate 51 are in the same direction as the transmission axis of the first absorptive polarization plate 41, the first polarization wave is transmitted successively through the second reflective polarization plate 52, the light guide plate 20 and the first reflective polarization plate 51 to exit to the back surface side. As a result, a viewer present at the back surface side can see a screen in which a state of the front surface side is displayed at positions corresponding to the off-state pixels and black display appears at positions correspond to the on-state pixels. In this manner, the light ray trajectories illustrated in FIG. 4 and FIG. 5 reveal that the display 12 also functions as a see-through display.

FIG. 6 illustrates light ray trajectories obtained when light emitted from the light guide plate 20 while the light source 25 is being turned on is transmitted to the front surface side and the back surface side in the display 12 illustrated in FIG. 4. With reference to FIG. 6, light ray trajectories of light emitted from the light guide plate 2 to the display surface side and the rear surface side while the light source 25 attached to the end portion of the light guide plate 20 is being turned on and the liquid-crystal panel 30 is in a driven state will be described.

With reference to FIG. 6, the first polarization wave emitted from the light guide plate 20 to the rear surface side is transmitted through the first reflective polarization plate 51 to be transmitted to the back surface side. Meanwhile, the first polarization wave emitted to the display surface side is transmitted through the second reflective polarization plate 52 and becomes incident on the first absorptive polarization plate 41. The light ray trajectories up to a point where the first polarization wave incident on the first absorptive polarization plate 41 is transmitted through the second absorptive polarization plate 42 to be transmitted to the front surface side are the same as the light ray trajectories illustrated in FIG. 3, and thus descriptions thereof will be omitted. Thus, the first polarization wave transmitted through an off-state pixel is converted to the second polarization wave by the liquid-crystal panel 30 and transmitted through the second absorptive polarization plate 42 to exit to the front surface side. The first polarization wave transmitted through an on-state pixel is incident on the second absorptive polarization plate 42 as is as the first polarization wave and is absorbed thereby.

The second polarization wave emitted from the light guide plate 20 to the rear surface side is reflected by the first reflective polarization plate 51 and becomes incident on the light guide plate 20. As the second polarization wave incident on the light guide plate 20 passes through a polarization scattering element within the light guide plate 20, turbulence is produced in the second polarization wave, which results in a combined wave of the first polarization wave and the second polarization wave, and the combined wave is emitted toward the second reflective polarization plate 52. The first polarization wave included in the combined wave is transmitted through the second reflective polarization plate 52 and becomes incident on the first absorptive polarization plate 41. The light ray trajectories from a point where the first polarization wave is incident on the first absorptive polarization plate 41 to a point where the light is transmitted to the front surface side are the same as the light ray trajectories of the first polarization wave emitted from the light guide plate 20 to the display surface side illustrated in FIG. 3, and thus descriptions thereof will be omitted.

The second polarization wave included in the combined wave is reflected by the second reflective polarization plate 52 and becomes incident on the light guide plate 20. As the second polarization wave incident on the light guide plate 20 passes again through the polarization scattering element within the light guide plate 20, a combined wave that includes the first polarization wave and the second polarization wave is generated, and the combined wave is emitted to the first reflective polarization plate 51. The first polarization wave included in the combined wave is transmitted through the first reflective polarization plate 51 to exit to the back surface side. Meanwhile, the second polarization wave is reflected by the first reflective polarization plate 51 and becomes incident on the light guide plate 20. In this manner, as the second polarization wave reflected by the first or second reflective polarization plate 51 or 52 passes through the polarization scattering element within the light guide plate 20, generation of a combined wave that includes the first polarization wave and the second polarization wave is repeated. The light ray trajectories of the second polarization wave emitted from the light guide plate 20 to the display surface side are also substantially the same as in the case of the second polarization wave emitted to the rear surface side as described above, and thus descriptions thereof will be omitted.

In this manner, the first polarization wave emitted from the light guide plate 20 to the display surface side and the first polarization wave included in the combined wave generated from the second polarization wave emitted from the light guide plate 20 to the rear surface side or the display surface side are converted to the second polarization wave upon being incident on an off-state pixel in the liquid-crystal panel 30 and are transmitted through the second absorptive polarization plate 42 to exit to the front surface side. Thus, a luminous state is displayed at a position corresponding to an off-state pixel in the liquid-crystal panel 30. In addition, the first polarization wave incident on an on-state pixel is emitted as-is as the first polarization wave and thus absorbed by the second absorptive polarization plate 42. Thus, black display appears at a position corresponding to an on-state pixel.

According to the second base study, not only the first polarization wave emitted from the light guide plate 20 to the display surface side but also the second polarization wave emitted to the display surface side and the rear surface side has turbulence produced therein upon passing through the polarization scattering element within the light guide plate 20. Thus, the combined wave that includes the first polarization wave and the second polarization wave is generated from the second polarization wave, and the first polarization wave included in the combined wave is also transmitted to the front surface side. In this case, in order to further improve the light utilization efficiency, the proportion of the first polarization wave included in the combined wave needs to be increased by increasing the polarization scattering element. To achieve ideal light utilization efficiency, the ratio of the first polarization wave and the second polarization wave included in the combined wave generated from the second polarization wave within the light guide plate 20 preferably satisfies the following expression (1).

first polarization wave:second polarization wave=1:1 (1)

The use of the light guide plate 20 that includes a large amount of polarization scattering element to satisfy the expression (1) leads to an improvement in the utilization efficiency of the second polarization wave; thus, the quantity of light of the second polarization wave transmitted to the front surface side increases, and the screen becomes brighter as a result. However, the turbidity (haze) that indicates the transparency of the guide plate 20 increases as well. An increase in the turbidity leads to a problem in that the screen as a whole becomes opaque to make the background blurry and less visible when the back surface side of the display 12 is seen from its front surface side.

Meanwhile, reducing the polarization scattering element leads to a decrease in the turbidity, which thus makes the screen less opaque and makes the background more visible. However, since the proportion of the first polarization wave included in the combined wave generated from the second polarization wave is reduced, the utilization efficiency of the second polarization wave cannot be improved. In addition, the quantity of light of the first polarization wave transmitted to the back surface side increases as compared to the first base study, and thus the problem that the viewer experiences more glare when seeing the display 12 from the back surface side is not solved, either.

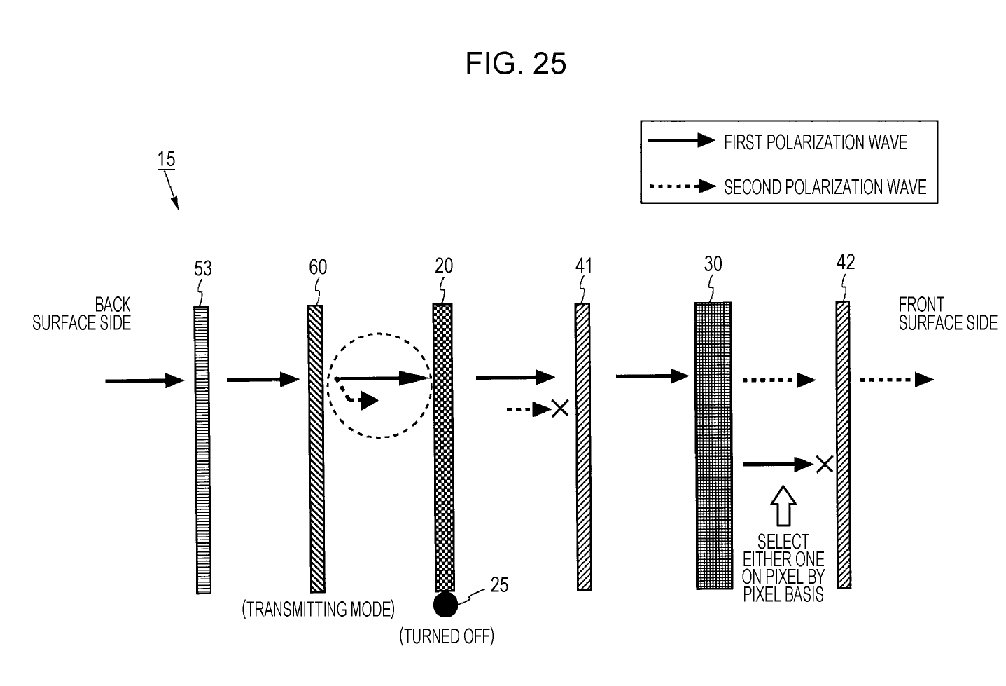

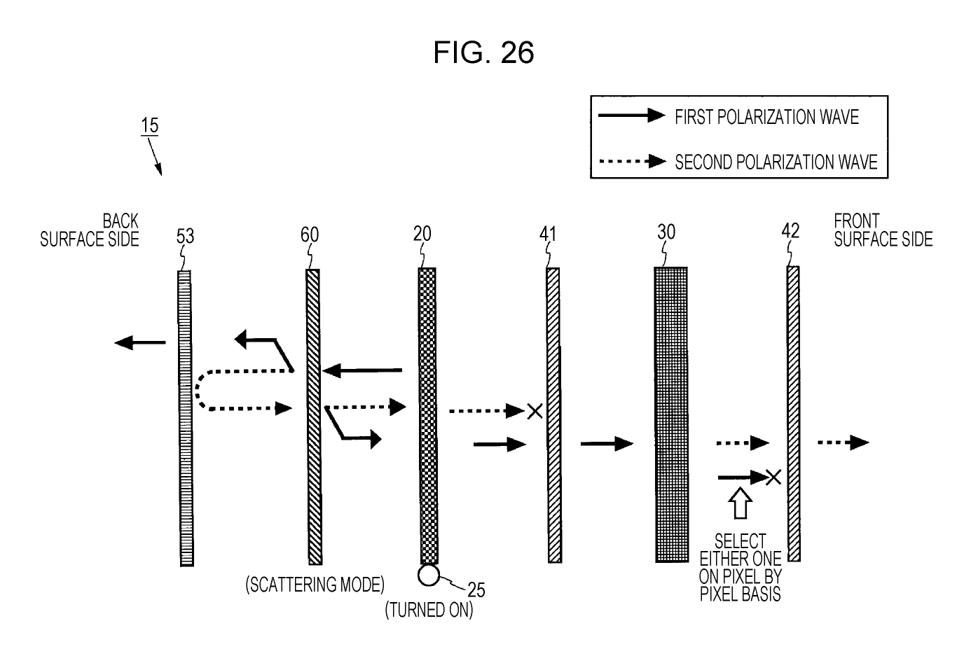

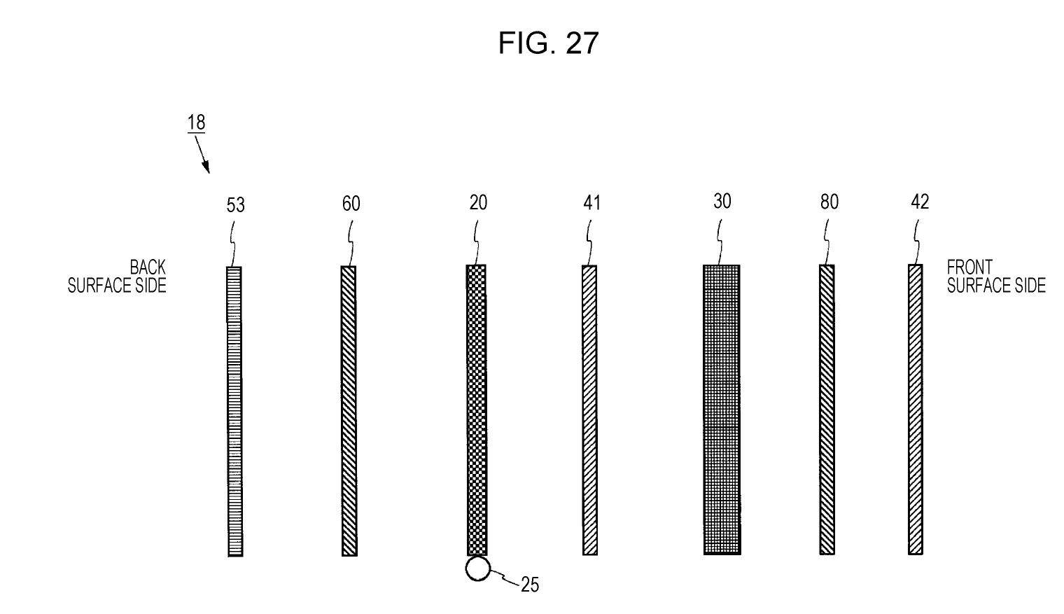

FIG. 7 illustrates a relationship between the turbidity of the light guide plate 20 and how the background is seen or the brightness of the screen. To be more specific, FIG. 7(A) illustrates a relationship between how the background is seen and the brightness of the screen when the turbidity is high, and FIG. 7(B) illustrates how the background is seen and the brightness of the screen when the turbidity is low. As illustrated in FIG. 7(A), when the turbidity is high, the screen is bright, but the background is blurred. However, as illustrated in FIG. 7(B), when the turbidity is reduced, the background can be seen more clearly, but the brightness of the screen is reduced.

### 2. First Embodiment

FIG. 8 is a block diagram illustrating a configuration of a liquid-crystal display device 110 according to a first embodiment.

### <2.1 Configuration and Operation of Display Device>

In the present invention, a well-known liquid-crystal display device is used as the liquid-crystal display device 110 that includes a display device described in detail in each embodiment below. Therefore, a configuration of the liquid-crystal display device 110 will be described briefly.

FIG. 8 is a block diagram illustrating a configuration of the liquid-crystal display device 110 including a display 15, which will be described later. As illustrated in FIG. 8, the liquid-crystal display device 110 is an active-matrix display device that includes the display 15, a display controlling circuit 112, a scan signal line driving circuit 113, and a data signal line driving circuit 114. This display 15 includes not only a liquid-crystal panel 30 but also a light guide plate to which a light source is attached and various polarization plates, but depictions of these components are omitted.

The liquid-crystal panel 30 included in the display 15 includes n scan signal lines G1 to Gn, m data signal lines S1 to Sm, and (m×n) pixels Pij (herein, m is an integer no smaller than 2, and j is an integer no smaller than 1 nor greater than m). The scan signal lines G1 to Gn are disposed parallel to each other, and the data signal lines S1 to Sm are disposed orthogonal to the scan signal lines G1 to Gn and parallel to each other. A pixel Pij is disposed in the vicinity of an intersection of a scan signal line Gi and a data signal line Sj. In this manner, the (m×n) pixels Pij are disposed two-dimensionally with m pixels Pij arrayed. In the row direction and with n pixels Pij arrayed in the column direction. The scan signal line Gi is connected in common to the pixels Pij disposed in an i-th row, and the data signal line Sj is connected in common to the pixels Pij disposed in a j-th column.

A control signal SC, such as a horizontal synchronization signal HSYNC or a vertical synchronization signal VSYNC, and an image signal DV are supplied externally to the liquid-crystal display device 110. On the basis of these signals, the display controlling circuit 112 outputs a clock signal CK and a start pulse ST to the scan signal line driving circuit 113 and outputs a control signal SC and an image signal DV to the data signal line driving circuit 114.

The scan signal line driving circuit. 113 provides high-level output signals successively, one by one, to the respective scan signal lines G1 to Gn. Thus, the scan signal lines G1 to Gn are selected successively, one by one, and the pixels Pij in each row are selected at once. The data signal line driving circuit 114 applies a signal voltage corresponding to the image signal DV to the data signal lines S1 to Sm on the basis of the control signal SC and the image signal DV. Thus, the signal voltage corresponding to the image signal DV is written into the pixels Pij in a selected row. In this manner, the liquid-crystal display device 110 displays an image on the liquid-crystal panel 30.

### <2.2 Configuration of Display>

FIG. 9 is a sectional view illustrating a configuration of the display 15 included in the liquid-crystal display device 110 according to the first embodiment. As illustrated in FIG. 9, in the display 15, a second absorptive polarization plate 42, the liquid-crystal panel 30, a first absorptive polarization plate 41, a light guide plate 20, a reverse-mode polymer-dispersed liquid-crystal element 60, and a reflective polarization plate 53 are disposed in this order from a front surface side toward a back surface side. In this manner, in the display 15, the reverse-mode polymer-dispersed liquid-crystal element 60 and the reflective polarization plate 53 are further disposed at the rear surface side of the light guide plate 20 in the display 11 illustrated in FIG. 1.

The light guide plate 20 is made of a transparent resin, such as acryl or polycarbonate, or glass and has a dot pattern formed in its front surface or has a diffusing agent, such as silica, added therein in order to allow the light incoming from the light source 25 to be emitted to the front surface side and the back surface side. For example, an LED (light-en body), serving as the light source 25, is attached to a side surface of the light guide plate 20. Therefore, when the light source 25 is turned on, the light emitted from the light source 25 enters the light guide plate 20, travels while repeatedly experiencing total reflection at the surface of the light guide plate 20, and is emitted from the light guide plate 20 to the display surface side or the rear surface side upon being incident on the dot pattern or the diffusing agent.

The polymer-dispersed liquid-crystal element 60, upon receiving a first polarization wave, a second polarization wave, or light including the first polarization wave and the second polarization wave, generates and emits the first polarization wave and the second polarization wave having their ratio adjusted to approach 1:1. FIG. 10 is a sectional view illustrating a configuration of the polymer-dispersed liquid-crystal element 60 that adjusts the proportions of the first polarization wave and the second polarization wave. To be more specific, FIG. 10(A) is a sectional view of the polymer-dispersed liquid-crystal element 60 that has entered a transmitting mode upon an electric field being turned on, and FIG. 10(B) is a sectional view of the polymer-dispersed liquid-crystal element 60 that has entered a scattering mode upon the electric field being turned off.

As illustrated in FIG. 10 (A), the polymer-dispersed liquid-crystal element 60 is an element in which a polymer network 63 and a liquid crystal are sealed in a space between two sealing members 61 each having a transparent electrode 62 formed thereon, and a class plate is used for the sealing members 61. As illustrated in FIG. 10(A), when the electric field is turned off by refraining from applying a voltage across the transparent electrodes 62, liquid-crystal molecules 64 in the liquid crystal sealed along with the polymer network 63 are arrayed in the same direction. In this case, the in light incident on the polymer-dispersed liquid-crystal element 60 is transmitted through the polymer-dispersed liquid-crystal element 60 without having its polarization direction converted thereby. For example, when the incident light is the first polarization wave, the transmitted light is also the first polarization wave. The mode of the polymer-dispersed liquid-crystal element 60 held in this case is referred to as a “transmitting mode.”

Meanwhile, as illustrated in FIG. 10(B), when the electric field is turned on by applying a voltage across the transparent electrodes 62, the liquid-crystal molecules 64 sealed along with the polymer network 63 become oriented randomly. In this case, the light incident on the polymer-dispersed liquid-crystal element 60 is scattered, and the ratio of the first polarization wave and the second polarization wave included in the scattered light is adjusted to approach 1:1. The mode of the polymer-dispersed liquid-crystal element 60 held in this case is referred to as a “scattering mode.” A reverse-mode polymer network/liquid-crystal composite film (PDLC (Polymer Dispersed Liquid Crystal)) is an example of the reverse-mode polymer-dispersed liquid-crystal element 60 that enters the transmitting mode when the electric field is off and enters the scattering mode when the electric field is on in the above-described manner.

In the present embodiment, the scattering mode and the transmitting mode of the polymer-dispersed liquid-crystal element 60 are switched therebetween in synchronization with the on/off of the light source 25. Specifically, the polymer-dispersed liquid-crystal element 60 enters the scattering mode when the light source 25 is turned on, and the polymer-dispersed liquid-crystal element 60 is switched to the transmitting mode when the light source 25 is turned off. In this manner, the modes of the polymer-dispersed liquid-crystal element 60 are synchronized with the on/off of the light source 25. Therefore, as will be described later, turning off the light source 25 and bringing the polymer-dispersed liquid-crystal element 60 into the scattering mode increases the proportion of light, of the light emitted from the light guide plate 20, that is transmitted to the front surface side, and the light utilization efficiency improves.

Alternatively, the polymer-dispersed liquid-crystal element 60 may enter the transmitting mode when the light source 25 is turned on, and the polymer-dispersed liquid-crystal element 60 may enter the scattering mode when the light source 25 is turned off, but the descriptions thereof will be omitted in the present specification.

Unlike the polymer-dispersed liquid-crystal element 60, a typical polymer-dispersed liquid-crystal element is of a normal type in which the polymer-dispersed liquid-crystal element enters the transmitting mode when the electric field is on and enters the scattering mode when the electric field is off. However, the polymer-dispersed liquid-crystal element 60 used in the present invention is of a reverse-mode type in which the polymer-dispersed liquid-crystal element 60 enters the scattering mode when the electric field is on and enters the transmitting mode when the electric field is off, as described above. A reason for this is that it is preferable to design the liquid-crystal display device 110 to function as a see-through display when the power source of the display 15 is turned off in order to reduce the power consumption of the liquid-crystal display device 110. Accordingly,in the following descriptions, the polymer-dispersed liquid-crystal element 60 is of a reverse-mode type, unless specifically indicated otherwise. However, in a case in which an increase in the power consumed while the liquid-crystal display device 110 is being used as a see-through display is not an issue, a polymer-dispersed liquid-crystal element of a normal type can also be used.

In the display 15, the transmission axis of the reflective polarization plate 53 and the transmission axis of the first absorptive polarization plate 41 are in the same direction, and the transmission axis of the first absorptive polarization plate 41 and the transmission axis of the second absorptive polarization plate 42 are orthogonal to each other.

### <2.3 Light Ray Trajectory>

FIG. 11 illustrates light ray trajectories obtained when light incident from the back surface side is transmitted to the front surface side in the display 15 illustrated in FIG. 9. As illustrated in FIG. 11, the polymer-dispersed liquid-crystal element 60 is in the transmitting mode and the light source 25 is being turned off. The second polarization wave incident from the back surface side is reflected by the reflective polarization plate 53 to the back surface side. Meanwhile, the first polarization wave incident from the back surface side is transmitted through the reflective polarization plate 53 and becomes incident on the polymer-dispersed liquid-crystal element 60. Since the polymer-dispersed liquid-crystal element 60 is in the transmitting mode, the first polarization wave is transmitted as-is as the first polarization wave without being converted. Since the transmission axis of the reflective polarization plate 53 and the transmission axis of the first absorptive polarization plate 41 are in the same direction, the first polarization wave is further transmitted through the light guide plate 20 and the first absorptive polarization plate 41 and becomes incident on the liquid-crystal panel 30.

The light ray trajectories of the first polarization wave incident on the liquid-crystal panel 30 are the same as in the case illustrated in FIG. 1 described in the first base study, and thus descriptions thereof will be omitted. Thus, the first polarization wave transmitted through an off-state pixel is converted to the second polarization wave, and the second polarization wave is transmitted through the second absorptive polarization plate 42 to exit to the front surface side. The first polarization wave transmitted through an on-state pixel is emitted as-is as the first polarization wave without being converted and is absorbed by the second absorptive polarization plate 42. As a result, a viewer present at the front surface side can see a screen in which a state of the back surface side is displayed at positions corresponding to the off-state pixels and black display appears at positions corresponding to the on-state pixels.

FIG. 12 illustrates light ray trajectories obtained when light incident from the front surface side is transmitted to the back surface side in the display 15 illustrated in FIG. 9. Similarly to the case illustrated in FIG. 11, the polymer-dispersed liquid-crystal element 60 is in the transmitting mode, and the light source 25 is being turned off in the case illustrated FIG. 12 as well. The first polarization wave incident from the front surface side is absorbed by the second absorptive polarization plate 42, and the second polarization wave is transmitted through the second absorptive polarization plate 42 and becomes incident on the liquid-crystal panel 30.

The first polarization wave incident on an on-state pixel of the liquid-crystal panel 30 is emitted as-is without being converted and is absorbed by the first absorptive polarization plate 41. Meanwhile, the second polarization wave incident on an off-state pixel is converted to the first polarization wave, is transmitted through the first absorptive polarization plate 41 and the light guide plate 20, and becomes incident on the polymer-dispersed liquid-crystal element 60. Since the polymer-dispersed liquid-crystal element 60 is in the transmitting. mode, the incident first polarization wave is transmitted as-is and becomes incident on the reflective polarization plate 53. Since the transmission axis of the reflective polarization plate 53 is in the same direction as the transmission axis of the first absorptive polarization plate 41, the first polarization wave is transmitted through the reflective polarization plate 53 to exit to the back surface side. As a result, a viewer present at the back surface side can see a screen in which a state of the front surface side is displayed at positions corresponding to the off-state pixels and black display appears at positions corresponding to the on-state pixels, in this manner, the light ray trajectories illustrated in FIG. 11 and FIG. 12 reveal that the display 15 functions as a see-through display.

FIG. 13 illustrates light ray trajectories obtained when light emitted from the light guide plate 20 while the light source 25 is being turned on is transmitted to the front surface side and the back surface side in the display 15 illustrated in FIG. 9. In this case, unlike the cases illustrated in FIG. 11 and FIG. 12, the polymer-dispersed liquid-crystal element 60 is in the scattering mode, and the light source 25 is being turned on. As illustrated in FIG. 13, the first polarization wave and the second polarization wave emitted from the light guide plate 20 to the display surface side are incident on the first absorptive polarization plate 41. The first absorptive polarization plate 41, of the incident light, absorbs the second polarization wave and transmits the first polarization wave. The light ray trajectories from a point where the first polarization wave transmitted through the first absorptive polarization plate 41 is incident on the liquid-crystal panel 30 to a point where the light is transmitted to the front surface side are the same as in the case illustrated in FIG. 6, and thus descriptions thereof will be omitted.

Meanwhile, the first polarization wave emitted from the light guide plate 20 to the rear surface side is incident on the polymer-dispersed liquid-crystal element 60, and then the polymer-dispersed liquid-crystal element 60 generates, from the incident first polarization wave, the first polarization wave and the second polarization wave having their ratio adjusted to approach 1:1 and emits the first polarization wave and the second polarization wave toward the reflective polarization plate 53. The first polarization wave is transmitted through the reflective polarization plate 53 to exit to the back surface side, and the second polarization wave is reflected by the reflective polarization plate 53 and becomes incident again on the polymer-dispersed liquid-crystal element 60.

The second polarization wave emitted from the light guide plate 20 to the rear surface side is incident on the polymer-dispersed liquid-crystal element 60 in the scattering mode, and then the polymer-dispersed liquid-crystal element 60 generates, from the incident second polarization wave, the first polarization wave and the second polarization wave having their ratio adjusted to approach 1:1 and emits the first polarization wave and the second polarization wave toward the reflective polarization plate 53. Of the incident light, the first polarization wave is transmitted through the reflective polarization plate 53 to exit to the back surface side. The second polarization wave is reflected by the reflective polarization plate 53 and becomes incident again on the polymer-dispersed liquid-crystal element 60. The polymer-dispersed liquid-crystal element 60 generates, from the second polarization wave reflected by the reflective polarization plate 53, the first polarization wave and the second polarization wave having their ratio adjusted to approach 1:1 and emits the first polarization wave and the second polarization wave toward the light guide plate 20. The first polarization wave and the second polarization wave are transmitted through the light guide plate 20 and become incident on the first absorptive polarization plate 41. The light ray trajectories of the first polarization wave and the second polarization wave thereafter are the same as the light ray trajectories of the first polarization wave and the second polarization wave emitted from the light guide plate 20 to the display surface side, and thus descriptions thereof will be omitted.

As a result, a viewer present at the front surface side can see a screen in which a luminous state is displayed at positions corresponding to the off-state pixels and black display appears at positions corresponding to the on-state pixels. In this manner, the display 15 can display a luminous state and black display in combination.

Next, a relationship between the light ray trajectories and the quantities of light in the display 11 used in the first base study and in the display 12 used in the second base study will be examined prior to describing a relationship between the light ray trajectories and the quantities of light in the display 15 according to the present embodiment. In any of the cases, the light source 25 is being turned on, the sum total of the quantities of light emitted from the light guide plate 20 to the display surface side and the rear surface side is “1,” and any loss is the quantities of light caused by various members is ignored.

FIG. 14 illustrates the light ray trajectories and the quantities of light in the light ray trajectories in the display 11 used in the first base study. As illustrated in FIG. 14, the proportions of the first and second polarization waves emitted from the light guide plate 20 to the display surface side and the rear surface side are each “0.25.” In this case, the proportions of the first and second polarization waves transmitted to the back surface side are each “0.25.” In addition, the proportion of the second polarization wave converted from the first polarization wave emitted from the light guide plate 20 to the display surface side and transmitted to the front surface side is also “0.25.” However, the second polarization wave emitted from the light guide plate 20 to the display surface side is absorbed by the first absorptive polarization plate 41 and cannot be transmitted to the front surface side. As a result, the proportion of the light transmitted to the front surface side is “0.25,” and the proportion of the light transmitted to the back surface side is “0.50.”

FIG. 15 illustrates the light ray trajectories and the quantities of light in the light ray trajectories in the display 12 used in the second base study. As illustrated in FIG. 15, in the second base study, of the first and second polarization waves emitted from the light guide plate the display surface side and the rear surface side, the proportions of the light transmitted to the front surface side and the back surface side without being reflected by the first and second reflective polarization plates 51 and 52 are each. “0.25.”

However, unlike the case of the first base study, the second polarization wave emitted from the light guide plate 20 to the rear surface side or the second polarization wave emitted from the light guide plate 20 to the display surface side and reflected by the second reflective polarization plate 52 is reflected by the first reflective polarization plate 51 and becomes incident again on the light guide plate 20. The second polarization wave incident on the light guide plate 20 is scattered upon passing through the polarization scattering element within the light guide plate 20 and results in a combined wave that includes the first polarization wave and the second polarization wave. The ratio of the first polarization wave and the second polarization wave included in this combined wave is typically not 1:1. Thus, when the proportion of the first polarization wave included in the combined wave is designated by “α,” “α” takes a value that satisfies the following expression (2).

α≤0.25 (2)

The first polarization wave that is included in the combined wave generated from the second polarization wave reflected by the first reflective polarization plate 51 and that has a proportion of “α” is transmitted through the second reflective polarization plate 52 and the first absorptive polarization plate 41 and becomes incident on the liquid-crystal panel 30. The first polarization wave incident on the liquid-crystal panel 30 is converted to the second polarization wave and transmitted through the second absorptive polarization plate 42 to exit to the front surface side. As a result, the proportion of the second polarization wave transmitted to the front surface side becomes “α.” Consequently, the proportions of the light transmitted to the front surface side and the light transmitted to the back surface side are each “0.25+α.”

FIG. 16 illustrates a relationship between the light ray trajectories and the quantities of light in the display 15 according to the present embodiment. As illustrated in FIG. 16, the proportions of the first and second polarization waves emitted from the light guide plate the display surface side and the rear surface side are each “0.25,” and the polymer-dispersed liquid-crystal element 60 is in the scattering mode.

The light emitted from the light guide plate 20 to the rear surface side and transmitted through the polymer dispersed liquid-crystal element 60 will be described. The light incident on the polymer-dispersed liquid-crystal element 60 includes the first polarization wave emitted from the light guide plate 20 to the rear surface side and having a proportion of “0.25” and the second polarization wave having a proportion of “0.25.” The first polarization wave is adjusted by the polymer-dispersed liquid-crystal element 60 so that the ratio of the first polarization wave and the second polarization wave approaches 1:1. As a result, the first polarization wave having a proportion of “0.25” is converted to the first polarization wave having a proportion of “0.125” and the second polarization wave having a proportion of “0.125.”

In a similar manner, the second polarization wave having a proportion of “0.25” is converted to the first polarization wave having a proportion of “0.125” and the second polarization wave having a proportion of “0.125.” As a result, the proportion of the first polarization wave emitted from the polymer-dispersed liquid-crystal element 60 toward the reflective polarization plate 53 is “0.25,” which is the sum of the proportions of “0.125” of the two first polarization waves described above. In a similar manner, the proportion of the second polarization wave emitted from the polymer-dispersed liquid-crystal element 60 to the reflective polarization plate 53 is also “0.25,” which is the sum of the proportions of: “0.125” of the two second polarization waves described above.

The first polarization waves generated from the first polarization wave and the second polarization wave in this manner and each having a proportion of “0.125” are transmitted through the reflective polarization plate 53 to exit to the back surface side. Meanwhile, the second polarization waves reflected by the reflective polarization plate 53 and each having a proportion of “0.125” are incident on the polymer-dispersed liquid-crystal element 60 and each result in the first polarization wave and the second polarization wave each having a proportion of “0.0625” upon their ratio being adjusted to approach 1:1 by the polymer-dispersed liquid-crystal element 60. The first polarization waves and the second polarization waves each having a proportion of “0.0625” are transmitted through the light guide plate and become incident on the first absorptive polarization plate 41.

The first absorptive polarization plate 41 absorbs the second polarization waves and transmits the first polarization waves, and thus the first polarization waves each having a proportion of “0.0625” are transmitted therethrough and become incident on the liquid-crystal panel 30. The second polarization waves converted by the liquid-crystal panel 30 are transmitted through the second absorptive polarization plate 42 to exit to the front surface side. At this point, the proportion of “0.125” of the first polarization wave emitted from the liquid-crystal panel 30 is the sum of the two first polarization waves incident on the liquid-crystal panel 30 and each having a proportion of “0.0625”. As a result, the proportion of the second polarization waves transmitted to the front surface side is “0.375,” which is the sum of “0.25” and “0.125.” Meanwhile, the proportion of the first polarization waves transmitted to the back surface side is “0.25,” which is the sum of “0.125” and “0.125.”

The results described above reveal the following. First, with regard to the second polarization waves transmitted to the front surface side, the case of the present embodiment will be compared with the case of the first base study and the case of the second base study. As illustrated in FIG. 14, in the first base study, the proportion of the first polarization wave transmitted to the front surface side is “0.25.” As illustrated in FIG. 15, in the second base study, the proportion of the first polarization waves transmitted to the front surface side is “0.25+α.” Since “a” takes a value within a range expressed by the expression (2) above, “0.25+α” is “0.5” at a maximum. In contrast, as illustrated in FIG. 16, the proportion is “0.375” in the case of the present embodiment. On the basis of these results, the second polarization wave of a larger quantity of light is transmitted to the front surface side in the case of the present embodiment than in the case of the first base study. However, in some cases, the second polarization wave of a larger quantity of light is transmitted to the front surface side in the case of the second base study than in the case of the present embodiment. If the quantity of light transmitted to the front surface side is increased in the second base study, the problem described later arises.

Meanwhile, with regard to the first polarization waves transmitted to the back surface side, the case of the present embodiment will be compared with the case of the first base study and the case of the second base study. As illustrated in FIG. 14, in the first base study, the light transmitted to the back surface side includes the first polarization wave having a proportion of “0.25” and the second polarization wave having a proportion of “0.25” Therefore, the proportion of the light transmitted to the back surface side is “0.50,” which is the sum of the stated two proportions. As illustrated in FIG. 15, in the second base study, only the first polarization wave is transmitted to the back surface side, and its proportion is “0.25+α.” Since “α” takes a value within a range expressed by the expression (2) above, the proportion is at least no smaller than “0.25.” In contrast, as illustrated in FIG. 16, in the case of the present embodiment, only the first polarization wave is transmitted to the back surface side, and its proportion is “0.25.” This reveals that the quantity of light transmitted to the back surface side is smaller in the case of the present embodiment than in the case of each base study. Furthermore, as described in the first base study, the light transmitted to the back surface side through the light guide plate 20 has a peak of brightness in a specific angular direction relative to the light guide plate 20. According to the present embodiment, however, the peak of the brightness is dispersed in broader angles than the specific angular direction. Accordingly, any glare experienced by a viewer is reduced.

FIG. 17 illustrates a summary of advantageous effects of the present embodiment in comparison to the cases of the first and second base studies. As compared to the case of the first base study, the quantity of light transmitted to the front surface side can be increased by 1.5 times in the present embodiment. Thus, the light utilization efficiency improves, and the screen can be made brighter. In addition, the quantity of light transmitted to the back surface side can be reduced to ½, and dispersing the peak of the brightness to broader angles makes it possible to reduce glare experienced when a viewer sees the display 15 from the back surface side. In the second base study, the quantity of light transmitted to the front surface side is “0.25+α,” and, depending on the value of “α,” the quantity of the transmitted light is greater than that in the case of the present embodiment, and thus the screen becomes brighter. However, as the value of “α” increases, so does the turbidity of the light guide plate 20, which in turn makes the background look more blurry when the background side is seen from the front surface side, as illustrated in FIG. 7(A). In contrast, in the present embodiment, a viewer can see a background displayed clearly on a bright screen.

### <2.4 Advantageous Effects>

According to the present embodiment, not only the first polarization wave emitted from the light guide plate 20 to the display surface side but also the first polarization wave included in the light converted, by the polymer-dispersed liquid-crystal element 60 in the scattering mode, from the first polarization wave and the second polarization wave emitted to the rear surface side is converted to the second polarization wave by the liquid-crystal panel 30 and transmitted to the front surface side. Thus, the utilization efficiency of the light emitted from the light guide plate 20 improves, and thus the screen can be made brighter.

In addition, a portion of the first polarization wave and the second polarization wave emitted from the light guide plate 20 to the rear surface side is reflected by the reflective polarization plate 53 to the display surface side, and thus the quantity of light of the first polarization wave transmitted to the back surface side is reduced. Thus, a viewer present at the back surface side is less likely to experience glare. Furthermore, when a viewer uses the display 15 as a see-through display, the viewer can see a background displayed clearly without any blur because the turbidity of the light guide plate 20 is reduced, although the brightness of the screen is reduced.

### 3. Second Embodiment

A configuration and an operation of a liquid-crystal display device according to the present embodiment are the same as in the case of the first embodiment illustrated in FIG. 8, and thus the drawing illustrating the configuration and descriptions thereof will be omitted. The configuration of a display 16 according to the present embodiment differs only in that a reflective polarization plate 54 that reflects a first polarization wave and transmits a second polarization wave is disposed in place of the second absorptive polarization plate 42, which is a constituent element of the display 15 according to the first embodiment illustrated in FIG. 9, and the arrangement of the other constituent elements is the same as in the case illustrated in FIG. 9. Thus, the drawing illustrating the configuration and descriptions thereof will be omitted.

### <3.1 Light Ray Trajectory >

FIG. 18 illustrates light ray trajectories obtained when light incident from a back surface side is transmitted to a front surface side in the display 16 according to the present embodiment. FIG. 19 illustrates light ray trajectories obtained when light incident from the front surface side is transmitted to the back surface side in the display 16 according to the present embodiment. FIG. 20 illustrates light ray trajectories obtained when light emitted from a light guide plate 20 while a light source 25 is being turned on is transmitted to the front surface side and the back surface side in the display 16. In FIG. 18 and FIG. 19, a polymer-dispersed liquid-crystal element 60 is in a transmitting mode, and the light source 25 is being turned off. In FIG. 20, the polymer-dispersed liquid-crystal element 60 is in a scattering mode, and the light source 25 is being turned on.

In any of the cases, the light ray trajectories of the first and second polarization waves incident from the back surface side, the second polarization wave incident from the front surface side, and the first and second polarization waves emitted from the light guide plate 20 are the same as in the case illustrated in FIG. 11, FIG. 12, and FIG. 13, respectively, and thus descriptions thereof will be omitted. However, in the present embodiment, the first polarization wave incident on the reflective polarization plate 54 from the front surface side is reflected by the reflective polarization plate 54 and directed back to the front surface side. In any of the cases, the first polarization wave transmitted through the liquid-crystal panel 30 and incident on the reflective polarization plate 54 is reflected by the reflective polarization plate 54 and becomes incident again on the liquid-crystal panel 30. This, however, is not directly related to the aim of the present embodiment, and thus descriptions thereof will be omitted.

### <3.2 Advantageous Effects>

According to the present embodiment, since the reflective polarization plate 54 is disposed on the display surface of the display 16, of the light incident on the reflective polarization plate 54 from the front surface side, the first polarization wave is reflected. Thus, a viewer present at the front surface side is in a state of facing a mirror due to the reflected first polarization wave, reflecting the front surface side, and the viewer can, for example, see the state of the back surface side displayed at positions corresponding to the off-state pixels in the case illustrated in FIG. 18 or see the luminous state displayed at positions corresponding to the off-state pixels in the case illustrated in FIG. 20. Thus, the display 16 serves as a well-designed display.

### 4. Third Embodiment

A configuration and an operation of a liquid-crystal display device according to the present embodiment are the same as in the case of the first embodiment illustrated in FIG. 8, and thus the drawing illustrating the configuration and descriptions thereof will be omitted. The configuration of a display 17 according to the present embodiment differs only in that a reflective polarization plate 55 is disposed in place of the first absorptive polarization plate 41 disposed between the liquid-crystal panel 30 and the light guide plate 20 among the constituent elements of the display 15 according to the first embodiment illustrated in FIG. 9, and the arrangement of the other constituent elements is the same as in the case illustrated in FIG. 9. Therefore, the drawing illustrating the configuration and descriptions thereof will be omitted. The polarization axis of the reflective polarization plate 55 is in the same direction as the polarization axis of a reflective polarization plate 53.

### <4.1 Might Ray Trajectory >

The display 17 according to the present embodiment, functioning as a see-through display, transmits the first polarization wave incident from the back surface side to the front surface side as the second polarization wave and transmits the second polarization wave incident from the front surface side to the back surface side as the first polarization wave. However, the respective light ray trajectories are substantially the same as those illustrated in FIG. 11 and FIG. 12 according to the first embodiment, and thus the drawing illustrating the light ray trajectories and descriptions thereof will be omitted.

FIG. 21 to FIG. 23 illustrate, in time series, light ray trajectories of the first and second polarization waves emitted from a light guide plate 20 and the quantities of light in the light ray trajectories in the display 17 according to the present embodiment. With reference to FIG. 21 to FIG. 23, the quantity of light in each light ray trajectory obtained when a light source 25 is being turned on and a polymer-dispersed liquid-crystal element 60 is in a scattering mode will be described. Of the light ray trajectories illustrated in FIG. 21 to FIG. 23, the light ray trajectories other than the light ray trajectories of the second polarization waves reflected by the reflective polarization plate 55 are the same as the light ray trajectories illustrated in FIG. 16, and thus descriptions thereof will be omitted.

As illustrated in FIG. 21, the proportions of the first polarization waves emitted from the light guide plate 20 toward the display surface side and the rear surface side are each “0.25.” Of the two, the first polarization wave emitted to the display surface side is transmitted through the reflective polarization plate 55, a liquid-crystal panel 30, and a second absorptive polarization plate 42 to exit to the front surface side. In this case, transmitted to the front surface side is the second polarization wave converted from the first polarization wave by the liquid-crystal panel 30, and the proportion of the second polarization wave is “0.25.” The first polarization wave emitted to the rear surface side is transmitted through the polymer-dispersed liquid-crystal element 60 in the scattering mode and the reflective polarization plate 53 to exit to the back surface side. In this case, transmitted to the back surface side is the second polarization wave, and the proportion of the second polarization wave is “0.25” as described in relation to FIG. 16.

The second polarization wave emitted from the light guide plate 20 to the display surface side is reflected by the reflective polarization plate 55 and directed to the back surface side. Thus, this second polarization wave is designated as “a second polarization wave A,” and the light ray trajectories thereof will be described with reference to FIG. 22.

The second polarization wave emitted from the light guide plate 20 to the rear surface side is transmitted through the polymer-dispersed liquid-crystal element 60 in the scattering mode and becomes incident on the reflective polarization plate 53. The reason why the proportion of the second polarization wave incident on the reflective polarization plate 53 becomes “0.25” has been described in relation to FIG. 16, and thus description thereof will be omitted.

The second polarization wave incident on the reflective polarization plate 53 is reflected thereby and becomes incident on the polymer-dispersed liquid-crystal element 60. The polymer-dispersed liquid-crystal element 60 generates, from the second polarization wave, the first polarization wave and the second polarization having their ratio adjusted to approach 1:1 and emits the first polarization wave and the second polarization wave. As a result, the proportions of the emitted first polarization wave and second polarization wave are each “0.125.” The first polarization wave and the second polarization wave are transmitted through the light guide plate 20 and become incident on the reflective polarization plate 55. The reflective polarization plate 55 transmits the first polarization wave having a proportion of “0.125” and reflects the second polarization wave having a proportion of “0.125.” The first polarization wave transmitted through the reflective polarization plate 55 is then transmitted through the liquid-crystal panel 30 and the second absorptive polarization plate 42 to exit to the front surface side. In this case, transmitted to the front surface side is the second polarization wave converted by the liquid-crystal panel 30, and the proportion of the second polarization wave is “0.125.”

The foregoing descriptions reveal that, in the stage illustrated in FIG. 21, the proportion of the second polarization wave transmitted to the front surface side is “0.375,” and the proportion of the first polarization wave transmitted to the back surface side is “0.375,” which is the sum of “0.25” and “0.125.”

The second polarization wave reflected by the reflective polarization plate 55 and having a proportion of “0.125” is designated as “a second polarization wave B,” and the light ray trajectories thereof obtained thereafter will be described with reference to FIG. 23.

Next, the light ray trajectories of the second polarization wave A illustrated in FIG. 21 will be described with reference to FIG. 22. The second polarization wave A is transmitted through the light guide plate 20 and becomes incident on the polymer-dispersed liquid-crystal element 60. The polymer-dispersed liquid-crystal element 60 generates, from the second polarization wave A, the first polarization wave and the second polarization wave having their ratio adjusted to approach 1:1 and emits the first polarization wave and the second polarization wave. Thus, the proportions of the emitted first polarization wave and second polarization wave each become “0.125.” The first polarization wave having a proportion of “0.125” is transmitted through the reflective polarization plate 53 to exit to the back surface side. The second polarization wave having a proportion of “0.125” is reflected by the reflective polarization plate 53.

The second polarization wave reflected by the reflective polarization plate 53 is incident again on the polymer-dispersed liquid-crystal element 60. The polymer-dispersed liquid-crystal element 60 generates, from the second polarization wave, the first polarization wave and the second polarization wave having their ratio adjusted to approach 1:1 and emits the first polarization wave and the second polarization wave. As a result, the proportions of the emitted first polarization wave and second polarization wave each become “0.0625.” The first polarization wave and the second polarization wave are transmitted through the light guide plate 20 and become incident on the reflective polarization plate 55. The reflective polarization plate 55 transmits the first polarization wave having a proportion of “0.0625” and reflects the second polarization wave having a proportion of “0.0625.” The first polarization wave transmitted through the reflective polarization plate 55 is then transmitted through the liquid-crystal panel 30 and the second absorptive polarization plate 42 to exit to the front surface side. In this case, the one that exits to the front surface side is the second polarization wave converted by the liquid-crystal panel 30, and the proportion of the second polarization wave is “0.0625.”

The foregoing descriptions reveal that, in the stage illustrated in FIG. 22, the proportion of the second polarization wave transmitted to the front surface side is “0.0625” and the proportion of the first polarization wave transmitted to the back surface side is “0.125.”

The second polarization wave emitted from the light guide plate 20 to the display surface side and having a proportion of “0.0625” is reflected by the reflective polarization plate 55. The descriptions of the light ray trajectories of this second polarization wave, or a second polarization wave C, obtained thereafter will be omitted.

Next, the light ray trajectories of the second polarization wave B illustrated in FIG. 21 will be described with reference to FIG. 23. The second polarization wave B reflected by the reflective polarization plate 53 and having a proportion of “0.125” is transmitted through the light guide plate 20 and becomes incident on the polymer-dispersed liquid-crystal element 60. The polymer-dispersed liquid-crystal element 60 generates, from the second polarization wave B, the first polarization wave and the second polarization wave having their ratio adjusted to approach 1:1 and emits the first polarization wave and the second polarization wave. As a result, the proportions of the emitted first polarization wave and second polarization wave each become “0.0625.” The first polarization wave having a proportion of “0.0625” is transmitted through the reflective polarization plate 53 to exit to the back surface side, and the second polarization wave having a proportion of “0.0625” is reflected by the reflective polarization plate 53.

The second polarization wave reflected by the reflective polarization plate 53 is incident on the polymer-dispersed liquid-crystal element 60. The polymer-dispersed liquid-crystal element 60 generates, from the second polarization wave, the first polarization wave and the second polarization having their ratio adjusted to approach 1:1 and emits the first polarization wave and the second polarization wave. As a result, the proportions of the emitted first polarization wave and second polarization wave each become “0.03125.” These first and second polarization waves are transmitted through the light guide plate 20 and become incident on the reflective polarization plate 55. The reflective polarization plate 55 transmits the first polarization wave having a proportion of “0.03125” and reflects the second polarization wave having a proportion of “0.03125.” The first polarization wave transmitted through the reflective polarization plate 55 is then transmitted through the liquid-crystal panel 30 and the first absorptive polarization plate 41 to exit to the front surface side. In this case, the one that exits to the front surface side is the second polarization wave converted by the liquid-crystal panel 30, and the proportion of the second polarization wave is “0.03125.”

The foregoing descriptions reveal that, in the stage illustrated in FIG. 23, the proportion of the second polarization wave transmitted to the front surface side is “0.03125” and the proportion of the first polarization wave transmitted to the back surface side is “0.0625.”

The second polarization wave emitted from the light guide plate 20 to the display surface side and having a proportion of “0.03125” is reflected by the reflective polarization plate 55. The descriptions of the light ray trajectories of this second polarization wave, or a second polarization wave D, obtained thereafter will be omitted.

In this manner, the second polarization wave emitted from the light guide plate 20 to the display surface side is reflected by the reflective polarization plate 55 and the reflective polarization plate 53, and the first polarization wave generated from the second polarization wave by the polymer-dispersed liquid-crystal element 60 is transmitted through the reflective polarization plate 55 to exit to the front surface side. Thus, the quantity of light of the second polarization wave that exits to the front surface side increases. In addition, the first polarization wave generated by the polymer-dispersed liquid-crystal element 60 is transmitted through the reflective polarization plate 53 to exit to the back surface side. Thus, the quantity of light of the first polarization wave that exits to the back surface side also increases. The proportion of the second polarization wave transmitted to the front surface side and the proportion of the first polarization wave transmitted to the back surface side further increase due to the second polarization wave C and the second polarization wave D, of which the descriptions are omitted in FIG. 22 and FIG. 23.

When the proportions of the second polarization waves transmitted to the front surface side and the back surface side are integrated, the result is “0.25” in the end. Meanwhile, as illustrated in FIG. 21, the first polarization wave emitted from the light guide plate 20 to the display surface side and having a proportion of “0.25” is converted by the liquid-crystal panel 30 and transmitted to the front surface side also as the second polarization wave having a proportion of “0.25.” As a result, of the light emitted from the light guide plate 20, the proportion of the second polarization wave transmitted to the front surface side becomes “0.50,” which is the sum of the aforementioned two.

FIG. 24 illustrates a summary of advantageous effects of the present embodiment in comparison to the cases of the first and second base studies. As compared to the case of the first base study, the quantity of light transmitted to the front surface side is increased by 2 times in the present embodiment; thus, the light utilization efficiency improves, and the screen can be made brighter. In the second base study, the quantity of light transmitted to the front surface side is “0.25+α,” and when the value of “α” is “0.25,” the proportion is the same as in the case of the present embodiment. Accordingly, in the case of the second base study as well, the light utilization efficiency can be improved to approximately the same level as in the case of the present embodiment. However, in the case of the second base study, as the value of “α” increases, so does the turbidity of the light guide plate 20, as described in relation to FIG. 17, which poses a problem in that the background is blurred when the back surface is seen from the front surface side. In contrast, in the present embodiment, a viewer can see a background displayed clearly on a bright screen.

### <4.2 Advantageous Effects>

According to the present embodiment, since the light guide plate 20 and the polymer-dispersed liquid-crystal element 60 are sandwiched by the two reflective polarization plates 53 and 55, the second polarization waves emitted from the light guide plate 20 to the display surface side and the rear surface side are converted to light that includes the first polarization wave and the second polarization wave at a ratio close to 1:1 by the polymer-dispersed liquid-crystal element 60 in the scattering mode while being reflected between the reflective polarization plates 53 and 55. The converted first polarization wave is transmitted through the reflective polarization plate 55 disposed toward the front surface of the light guide plate 20 and is transmitted to the front surface side, and thus the quantity of light transmitted to the front surface side can be increased. As a result, the light utilization efficiency can be further improved, and the screen can be made even brighter.

### 5. Fourth Embodiment

A characteristic feature of a liquid-crystal display device according to the present embodiment lies in the configuration of the polymer-dispersed liquid-crystal element 60 included in the displays 15 to 17 described above. A configuration and an operation of the liquid-crystal display device according to each of the following embodiments are the same as the configuration and the operation illustrated in FIG. 8, and thus the drawing and descriptions thereof will be omitted.

In the polymer-dispersed liquid-crystal element 60 described in the first embodiment, if a film sheet that exhibits birefringence is used as the sealing members 61 for sealing the polymer network 63 and the liquid crystal, the following problems arise.

FIG. 25 is an illustration for describing light ray trajectories of light transmitted from a back surface side to a front surface side in a state in which a film sheet that exhibits birefringence is used as the sealing members 61 of the polymer-dispersed liquid-crystal element 60 and the light source 25 is being turned on in the display 15 illustrated in FIG. 1. In this case, the first polarization wave incident on the polymer-dispersed liquid-crystal element 60 in the transmitting mode cannot be transmitted through the polymer-dispersed liquid-crystal element 60 as-is as the first polarization wave and undergoes birefringence through the sealing members 61 that exhibit birefringence. Thus, the light emitted from the polymer-dispersed liquid-crystal element 60 includes the second polarization wave, for example, in a manner in which the ratio of the first polarization wave and the second polarization wave is 0.9:0.1, and the proportion of the first polarization wave is reduced by that amount. Thereafter, the first polarization wave is transmitted through the first absorptive polarization plate 41, the second polarization wave converted by the liquid-crystal panel 30 is then transmitted to the front surface side, and the second polarization wave is absorbed by the first absorptive polarization plate 41. The quantity of light of the second polarization wave transmitted to the front surface side is smaller than that in the case illustrated in FIG. 11, and thus the brightness of the screen is reduced.

FIG. 26 is an illustration for describing light ray trajectories of light emitted from the light guide plate 20 in a state in which a film sheet that exhibits birefringence is used as the sealing members 61 of the polymer-dispersed liquid-crystal element 60 and the light source 25 is being turned on. In this case, the second polarization wave emitted from the light guide plate 20 to the rear surface side, upon being incident on the polymer-dispersed liquid-crystal element 60 in the scattering mode, undergoes birefringence by the film sheet serving as the sealing members 61 that exhibit birefringence, instead of coming to Include the first polarization wave and the second polarization wave in a ratio close to 1:1. Thus, the light emitted from the polymer-dispersed liquid-crystal element 60 includes the second polarization wave in a greater amount, for example, as in a manner in which the ratio of the first polarization wave and the second polarization wave is 0.4:0.6, and the first polarization wave is reduced by that amount. Thereafter, the first polarization wave is transmitted through the first absorptive polarization plate 41, and the second polarization wave converted by the liquid-crystal panel 30 is then transmitted to the front surface side. The quantity of light of this second polarization wave is smaller than that in the case illustrated in FIG. 13, and thus the brightness of the screen is reduced.

Therefore, instead of a film sheet that exhibits birefringence, a film sheet that does not exhibit birefringence is used as the sealing members 61 of the polymer-dispersed liquid-crystal element 60. Thus, the polymer-dispersed liquid-crystal element 60 emits the incident first polarization wave as-is while the polymer-dispersed liquid-crystal element 60 is in the transmitting mode and emits the first polarization wave and the second polarization wave having their ratio adjusted to approach 1:1 while the polymer-dispersed liquid-crystal element 60 is in the scattering mode. Thereafter, the first polarization wave is transmitted through the first absorptive polarization plate 41, and the second polarization wave converted by the liquid-crystal panel 30 is then transmitted to the front surface side. In either case, the quantity of light of the second polarization wave transmitted to the front surface side is increased as compared to those in the cases illustrated in FIG. 25 and FIG. 26, and thus the screen becomes brighter.

In this manner, by using a film sheet that does not exhibit birefringence as the sealing members 61 of the polymer-dispersed liquid-crystal element 60, an occurrence of birefringence at the sealing members 61 is suppressed. Thus, a decrease in the quantity of transmitted light transmitted through the polymer-dispersed liquid-crystal element 60 can be prevented; thus, the light utilization efficiency improves, and the screen can be made brighter. As such a film that does not exhibit birefringence, for example, a TAC (Triacetylcellulose) film manufactured through solution-casting thin-film formation can be used.

In addition, a glass plate that does not exhibit birefringence may also be used as the sealing members 61 that do not exhibit birefringence. Thus, not only can the screen be made brighter, but also the rigidity of the display can be improved as compared to the case in which a film sheet is used. The method of manufacturing a glass plate that does not exhibit birefringence is well known, and thus descriptions thereof will be omitted. In some cases, a film sheet that does not exhibit birefringence is referred to as “an isotropic film sheet,” and a glass plate that does not exhibit birefringence is referred to as “an isotropic glass plate.”

### 6. Others

In each of the foregoing embodiments, the light source 25 may be attached to any two or three sides or the four sides of the side surface of the light guide plate 20, aside from being attached to one side of the side surface.

In each of the foregoing embodiments, each of the displays 15 to 17 displays an image and a background in black and white but may instead display an image and a background in color. A color display can be achieved only by slightly modifying the configurations of the displays 15 to 17, and the description is given below with the display 15 according to the first embodiment serving as an example. FIG. 27 is a sectional view illustrating a configuration of a display 18 of a color filter type that displays an image and a background in color. As illustrated in FIG. 27, in the display 18, a color filter 80 is disposed between a liquid-crystal panel 30 and a second absorptive polarization plate 42. Thus, the light emitted from the light guide plate 20 or the light incident from the front surface side or the back surface side is transmitted through the color filter 80, and thus the image and the background are displayed in color.

In each of the foregoing embodiments, the liquid-crystal panel 30 driven in a TN system is used as an element for controlling the polarization state of the light transmitted through the displays 15 to 17. However, the liquid-crystal panel that can be used is not limited to one of a TN system. For example, any element, including an element driven in another system such as a VA (Vertical Alignment) system, that is capable of such control of allowing a polarization wave to be transmitted therethrough in one of a driven state and a non-driven state while being sandwiched by two polarization plates and of not allowing the polarization wave to be transmitted therethrough in the other one of the driven state and the non-driven state may be used. Thus, such an element is referred to as “a polarization modulating element” in some cases.

In addition, in order for the displays 15 to 17 to function as a see-through display, the polarization modulating element may be of either a normally white type or a normally black type. However, in the case of the normally white type, the display becomes transparent when the polarization modulating element is in an off state, namely, while not being driven. In contrast, in the case of the normally black type, the display, becomes transparent when the polarization modulating element is in an on state, namely, while being driven. In this manner, the polarization modulating element of a normally black type needs to be driven not only when displaying an image but also when entering in a see-through state. Therefore, the polarization modulating element of a normally white type is advantageous in that it can be driven with less power consumption as compared to the polarization modulating element of a normally black type.

In addition, the polymer-dispersed liquid-crystal element 60 is used as an element that can adjust the ratio of the first polarization wave and the second polarization wave to approach 1:1 in the scattering mode and that can transmit as-is in the transparent mode. However, such an element is not limited to the polymer-dispersed liquid-crystal element 60, and any element that has the functions as described above may be used. Thus, such an element is referred to as “a light scattering switching element” in some cases. Such a light scattering switching element is preferably of a reverse-mode type regardless of its type.

In some cases, the first absorptive polarization plate 41 and the reflective polarization plate 55 according to the foregoing embodiments are collectively referred to as “a first polarization plate,” and the second absorptive polarization plate 42 and the reflective polarization plate 54 are collectively referred to as “a second polarization plate.”

The present application claims priority to Japanese Patent Application No. 2016-107690, titled “display device,” filed on May 30, 2016, and the content of which is incorporated herein by reference.

### REFERENCE SIGNS LIST

15, 16, 17 DISPLAY

LIGHT GUIDE PLATE

LIGHT SOURCE

LIQUID-CRYSTAL PANEL (POLARIZATION MODULATING ELEMENT)

FIRST ABSORPTIVE POLARIZATION PATE

SECOND ABSORPTIVE POLARIZATION PLATE

FIRST REFLECTIVE POLARIZATION PLATE

SECOND REFLECTIVE POLARIZATION PLATE

REFLECTIVE POLARIZATION PLATE

REFLECTIVE POLARIZATION PLATE

REFLECTIVE POLARIZATION PLATE

POLYMER-DISPERSED LIQUID-CRYSTAL ELEMENT (LIGHT

SCATTERING SWITCHING ELEMENT)

SEALING MEMBER

POLYMER NETWORK

LIQUID-CRYSTAL MOLECULE

COLOR FILTER

1. A display device: comprising a display that displays an image based on an image signal and that also functions as a see-through display,
wherein the display includes
a light source that emits light including a first polarization wave and a second polarization wave, the second polarization wave having a polarization axis orthogonal to a polarization axis of the first polarization wave,
a light guide plate that emits the light from the light source toward a display surface side and a rear surface side of the display,
a light scattering switching element disposed on a rear surface of the light guide plate, the light scattering switching element having a transmitting mode in which the light scattering switching element outputs an incident polarization wave without converting a polarization state of the incident polarization wave and a scattering mode in Which the light scattering switching element carries out a conversion to cause a ratio of the first polarization wave and the second polarization wave to approach 1:1 and outputs the first polarization wave and the second polarization wave,
a reflective polarization plate disposed on a rear surface of the light scattering switching element, and
a first polarization plate, a polarization modulating element, and a second polarization plate that are disposed in this order from the light guide plate toward the a front surface side,
wherein the polarization modulating element includes a plurality of pixels to which a voltage can be applied, controls a polarization state of the first polarization wave or the second polarization wave incident on the pixels with the voltage, and outputs the first polarization wave or the second polarization wave, and
wherein the reflective polarization plate and the first polarization plate transmit one polarization wave of the first polarization wave and the second polarization wave, and the second polarization plate transmits the other polarization wave.

2. The display device according to claim 1,
wherein the first polarization plate and the second polarization plate are both absorptive polarization plates.

3. The display device according to claim 1,
wherein the first polarization plate is an absorptive polarization plate, and the second polarization plate is a reflective polarization plate.

4. The display device according to claim 1,
wherein the first polarization plate is a reflective polarization plate, and the second polarization plate is an absorptive polarization plate.

5. The display device according to claim 2,
wherein the polarization modulating element is a liquid-crystal panel.

6. The display device according to claim 5,
wherein the liquid-crystal panel is a normally white panel.

7. The display device according to claim 5,
wherein the liquid-crystal panel is a panel of a twisted nematic system.

8. The display device according to claim 1, further comprising:
a color filter disposed between the polarization modulating element and the second polarization plate.

9. The display device according to claim 1,
wherein the light source includes a plurality of types of light-emitting bodies that emit light that can express at least white and causes the plurality of light-emitting bodies to emit light successively in time division.

10. The display play device according to claim 1,
wherein the light scattering switching element enters the scattering mode when an electric field is turned on and enters the transmitting mode when the electric field is turned off.

11. The display device according to claim 10,
wherein the light scattering switching element includes a liquid-crystal layer, a polymer network formed within the liquid-crystal layer, and a sealing member having an electrode formed on a surface thereof, the light scattering switching element being a polymer-dispersed liquid-crystal element having a structure in which the liquid-crystal layer and the polymer-dispersed liquid-crystal element are sandwiched by the sealing member.

12. The display device according to claim 11,
wherein the sealing member of the light scattering switching element is either an isotropic film sheet or an isotropic glass plate.
